(19) United States
(12) Patent Application Publication
(10) Pub. No.: US 2024/0400400 A1
(43) Pub. Date: Dec. 5, 2024

(54) ZEOLITE SYNTHESES UTILIZING BIS-PYRIDINIUM STRUCTURE DIRECTING AGENTS

(71) Applicant: ExxonMobil Technology and Engineering Company, Annandale, NJ (US)

(72) Inventors: Allen W. Burton, Stewartsville, NJ (US); Hilda B. Vroman, Piscataway, NJ (US); Trong D. Pham, Flemington, NJ (US); Eugene A. Terefenko, Center Valley, PA (US)

(21) Appl. No.: 18/690,620

(22) PCT Filed: Aug. 11, 2022
(86) PCT No.: PCT/US2022/074822

§ 371 Date: Mar. 8, 2024

Related U.S. Application Data
(60) Provisional application No. 63/251,251, filed on Oct. 1, 2021.
(60) Provisional application No. 63/244,760, filed on Sep. 16, 2021.

(51) Int. Cl. C01B 39/48

(52) U.S. Cl. CPC C01B 39/48; C01P 2002/72; C01P 2004/03

(57) ABSTRACT

Various zeolites may be produced under hydrothermal synthesis conditions in the presence of a silicon atom source and a bis-pyridinium compound having a structure represented by formula (I). Q is an optionally substituted C1-C10 hydrocarbyl group and two Q may join to form a carbocyclic ring; n is an integer ranging from 0 to 5; m is an integer ranging from 0 to 5; n+m is greater than or equal to 1; and A is a spacer group containing 2 to about 10 atoms.

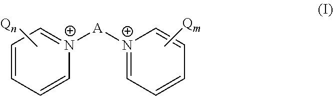

### CROSS-REFERENCE TO RELATED APPLICATIONS

The present application claims priority to and the benefit of U.S. Provisional Application No. 63/244,760, filed on Sep. 16, 2021, and of U.S. Provisional Application No. 63/251,251, filed on Oct. 1, 2022, which are hereby incorporated by reference in their entirety.

### FIELD

The present disclosure relates to zeolites and, more particularly, zeolite syntheses using structure directing agents (SDAs).

### BACKGROUND

Zeolites are a diverse class of crystalline microporous inorganic framework materials, which are widely used as molecular sieves, ion exchangers, and solid acid catalysts. Crystallinity may be determined by the ability of a zeolite to exhibit an X-ray powder diffraction pattern. The inorganic framework defining a particular zeolite is characterized by a plurality of pores or channels of specified size that are present therein. Alternately, several populations of pore sizes may be present in a given zeolite, which are interconnected by still smaller pores or channels. By virtue of their defined-size porosity, zeolites may find utility as sorbents and facilitate catalytic reactions of various optionally substituted hydrocarbon compounds.

Natural and synthetic zeolites may include a wide variety of cation-containing crystalline silicates and substituted silicates, in which silicon atoms may be partially or completely replaced by other polyvalent elements. Such silicates may feature a rigid three-dimensional framework of SiO₄ tetrahedra and optionally tetrahedra comprising a trivalent element oxide, such as AlO₄ and/or BO₄, in which the tetrahedra may be crosslinked by sharing oxygen atoms and a local ratio of the total trivalent element and silicon atoms to oxygen atoms is 1:2. Electrical neutrality may be maintained in tetrahedra containing a trivalent element through inclusion of a cation, such as an alkali metal or an alkaline earth metal cation that is not part of the tetrahedral structure but is instead associated therewith through charge pairing. One type of cation may be exchanged for another to vary the properties attainable from a given silicate. Tetravalent and pentavalent elements may also be introduced to the inorganic framework structure of zeolites in some instances.

Zeolites are frequently synthesized in the presence of an organic structure directing agent (SDA), such as alkylammonium cations, to promote templated formation of the inorganic framework structure. For example, ZSM-5 may be synthesized in the presence of tetrapropylammonium cations. Zeolite MCM-22 may be synthesized in the presence of a neutral amine, hexamethyleneimine. There are many other examples of SDAs available for producing other various zeolites. To expand the range of zeolite framework structures accessible through synthesis and/or to improve the synthesis of existing zeolite framework structures, improved syntheses utilizing SDAs are desirable.

### SUMMARY

In some aspects, the present disclosure provides compositions comprising: an at least partially crystalline network structure (or zeolite framework structure or zeolite) comprising a silicate having a plurality of pores or channels defined therein; and a bis-pyridinium compound present in at least a portion of the pores or channels, the bis-pyridinium compound having a structure represented by:

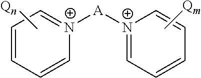

wherein Q is an optionally substituted C₁-C₁₀ hydrocarbyl group and two Q may join to form a carbocyclic ring, n is an integer ranging from 0 to 5, m is an integer ranging from 0 to 5, n+m is greater than or equal to 1, and A is a spacer group containing 2 to about 10 atoms.

In some aspects, the present disclosure provides compositions comprising: an at least partially crystalline network structure (or zeolite framework structure or zeolite) comprising a silicate having a plurality of pores or channels defined therein, prepared by a process comprising: combining in an aqueous medium a silicon atom source and a bis-pyridinium compound having a structure represented by:

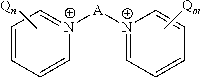

wherein Q is an optionally substituted C₁-C₁₀ hydrocarbyl group and two Q may join to form a carbocyclic ring, n is an integer ranging from 0 to 5, m is an integer ranging from 0 to 5, n+m is greater than or equal to 1, and A is a spacer group containing 2 to about 10 atoms; heating the aqueous medium under crystallization conditions; obtaining the at least partially crystalline network structure from the aqueous medium; and calcining the at least partially crystalline network structure in air or oxygen to remove the bis-pyridinium compound from the at least partially crystalline network structure; wherein the at least partially crystalline network structure has a framework type selected from the group consisting of EMM-69 and EMM-XY.

In some or other aspects, the present disclosure provides zeolite synthesis processes comprising: combining in an aqueous medium a silicon atom source and a bis-pyridinium compound having a structure represented by:

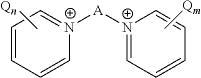

wherein Q is an optionally substituted C₁-C₁₀ hydrocarbyl group and two Q may join to form a carbocyclic ring, n is an integer ranging from 0 to 5, m is an integer ranging from 0 to 5, n+m is greater than or equal to 1, and A is a spacer group containing 2 to about 10 atoms; heating the aqueous medium under crystallization conditions; and obtaining an at least partially crystalline network structure from the aqueous medium.

These and other features and attributes of the disclosed methods and compositions of the present disclosure and their advantageous applications and/or uses will be apparent from the detailed description which follows.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one having ordinary skill in the art and having the benefit of this disclosure.

To assist one of ordinary skill in the relevant art in making and using the subject matter hereof, reference is made to the appended drawings, wherein:

FIG. 1 shows a plot of comparative powder XRD patterns for various Beta zeolites made using a bis-pyridinium compound having Structure 13 as an SDA (Samples 9-11), pre-calcination (as-made).

FIG. 2 shows a plot of the powder XRD pattern of Beta zeolite produced under scale-up conditions using the bis-pyridinium compound having Structure 13 as an SDA (Sample 13), pre-calcination (as-made).

FIGS. 3A and 3B show illustrative SEM images at various magnifications of Beta zeolite produced under scale-up conditions using the bis-pyridinium compound having Structure 13 as an SDA (Sample 13), pre-calcination (as-made).

FIG. 4 shows a plot of comparative powder XRD patterns of Sample 24 pre-calcination (as-made) and post-calcination, made using the bis-pyridinium compound having Structure 27 as an SDA.

FIG. 5 shows a plot of comparative powder XRD patterns of Samples 25, 26, and 43 made using the bis-pyridinium compounds having Structures 15 and 17 as an SDA, post-calcination.

FIGS. 6A and 6B show illustrative SEM images of Sample 43 pre-calcination (as-made) at various magnifications, made using the bis-pyridinium compound having Structure 17 as an SDA.

FIG. 7 shows a plot of comparative powder XRD patterns of Sample 44 produced using EMM-69 seeds and the bis-pyridinium compound having Structure 17 as an SDA, pre-calcination (as-made) and post-calcination.

FIGS. 8A and 8B show illustrative SEM images of Sample 54 pre-calcination (as-made) at various magnifications, made using the bis-pyridinium compound having Structure 17 as an SDA.

FIGS. 9A and 9B show illustrative SEM images of the zeolite mixture of Sample 55 pre-calcination (as-made) at various magnifications, made using the bis-pyridinium compound having Structure 17 as an SDA.

FIGS. 10A and 10B show illustrative SEM images of Sample 65 at various magnifications, made using the bis-pyridinium compound having Structure 18 as an SDA.

FIGS. 11A and 11B show illustrative SEM images of Sample 67 at various magnifications, made using the bis-pyridinium compound having Structure 18 as an SDA.

FIG. 12 shows a plot of comparative powder XRD patterns of Sample 77 pre-calcination (as-made) and post-calcination, made using the bis-pyridinium compound having Structure 18 as an SDA.

FIGS. 13A and 13B show illustrative SEM images of Sample 77 at various magnifications, made using the bis-pyridinium compound having Structure 18 as an SDA.

FIG. 14 shows a plot of the powder XRD pattern of Sample 78 pre-calcination (as-made), made using the bis-pyridinium compound having Structure 18 as an SDA.

FIGS. 15A and 15B show illustrative SEM images of Sample 78 at various magnifications, made using the bis-pyridinium compound having Structure 18 as an SDA.

FIG. 16 shows a plot of comparative powder XRD patterns of Sample 80 pre-calcination (as-made) and post-calcination, using the bis-pyridinium compound having Structure 18 as an SDA.

FIG. 17 shows a plot of comparative powder XRD patterns of Sample 89 pre-calcination (as-made) and post-calcination, made using the bis-pyridinium compound having Structure 20 as an SDA.

FIGS. 18A and 18B show illustrative SEM images of Sample 89 at various magnifications, made using the bis-pyridinium compound having Structure 20 as an SDA.

### DETAILED DESCRIPTION

The present disclosure relates to zeolite syntheses and, more particularly, zeolite syntheses using structure directing agents (SDAs).

The present disclosure expands the range of SDAs applicable for synthesizing zeolites. In particular, the present disclosure provides bis-pyridinium compounds (quaternized bis-pyridines) that may be utilized to synthesize known zeolite framework structures or new zeolite framework structures, including known zeolite framework structures having wider compositional ranges than are available through conventional syntheses. Bis-pyridinium compounds constitute a family of readily available heterocyclic compounds that have attracted attention in recent years as synthetic components having useful redox properties. Such compounds have played a central role in the development of photoactivated electron-transfer reactions, and further found applications, for example, in energy conversion, synthetic methodology, and electrochromic devices. Advantageously, the zeolite framework structure produced when using a bis-pyridinium compound may vary depending on how the pyridine rings are substituted and the spacer length in between, as discussed in further detail herein. Additional synthetic variation may also impact the type of zeolite framework structure produced.

Despite their utility in other applications, bis-pyridinium compounds are believed to have remained unexplored as SDAs, at least in part due to their perceived instability under alkaline conditions, such as in the presence of hydroxide that is commonly present during zeolite syntheses. The present disclosure surprisingly demonstrates that bis-pyridinium compounds substituted with one or more electron-donating groups, preferably one or more hydrocarbyl groups on each pyridine ring and more preferably one or more alkyl groups on each pyridine ring, may be sufficiently stable to facilitate zeolite formation under appropriate synthetic conditions. Without being bound by any theory or mechanism, it is believed that the electron-donating groups on the pyridine rings increase stability toward degradation under alkaline conditions. Various zeolite framework structures that are inaccessible with conventional SDAs may be produced using at least some of the bis-pyridinium compounds disclosed herein. In addition, a wider compositional range of some previously known zeolite framework structures may be accessed through application of the disclosure herein.

Before describing the processes and compositions of the present disclosure in further detail, a listing of terms follows to aid in better understanding the present disclosure.

All numerical values within the detailed description and the claims herein are modified by “about” or “approximately” with respect to the indicated value, and take into account experimental error and variations that would be expected by a person having ordinary skill in the art. Unless otherwise indicated, ambient temperature (room temperature) is about 25° C.

As used in the present disclosure and claims, the singular article forms “a,” “an,” and “the” include plural forms unless the context clearly dictates otherwise.

The term “and/or” as used in a phrase such as “A and/or B” herein is intended to include “A and B,” “A or B,” “A,” and “B.”

For the purposes of the present disclosure, the new numbering scheme for groups of the Periodic Table is used. In said numbering scheme, the groups (columns) are numbered sequentially from left to right from 1 through 18.

As used herein, the term “hydrocarbon” refers to an organic compound or mixture of organic compounds that includes the elements hydrogen and carbon. Optionally substituted hydrocarbons may also include other elements, such as, but not limited to, halogens, metallic elements, nitrogen, oxygen, sulfur, and any combination thereof. Unless otherwise specified, hydrocarbons may be one or more of linear, branched, cyclic, acyclic, saturated, unsaturated, aliphatic, or aromatic.

As used herein, the term “silicate” refers to a substance containing at least silicon and oxygen atoms that are alternately bonded to each other (i.e., —O—Si—O—Si—) in an inorganic framework structure (framework silicate), and optionally including other atoms within the inorganic framework structure. Optional atoms that may be present in the inorganic framework structure include atoms such as, for example, boron, aluminum, or other metals (e.g., transition metals, such as titanium, vanadium, or zinc). Atoms other than silicon in the inorganic framework structure occupy a portion of the lattice sites otherwise occupied by silicon atoms in an ‘all-silica’ framework silicate. Thus, the term “silicate,” as used herein, refers to an atomic lattice comprising any of a silicate, borosilicate, gallosilicate, ferrisilicate, aluminosilicate, titanosilicate, zincosilicate, vanadosilicate, or the like. A silicate or similar at least partially crystalline network structure exhibits an x-ray powder diffraction pattern.

As used herein, the term “aqueous medium” refers to a liquid comprising predominantly water, such as about 90 vol % water or greater. Suitable aqueous media may comprise or consist essentially of water or mixtures of water and a water-miscible organic solvent.

As used herein, the term “trivalent” refers to an atom having a +3 oxidation state.

As used herein, the term “tetravalent” refers to an atom having a +4 oxidation state.

As used herein, the term “structure directing agent (SDA)” refers to a templating compound that may promote zeolite synthesis.

As used herein, the terms “calcine,” “calcination,” and similar variants thereof refer to the process of heating in air or oxygen above a specified temperature.

As used herein, the term “hydrothermal synthesis” refers to a process in which water and reactants are heated in a closed vessel at a specified temperature and for a specified time.

As used herein, the term “alpha value” refers to a measure of the catalytic activity of a zeolite (e.g., cracking activity). The catalytic activity characterized as the “alpha value” may refer to the first order rate constant of n-hexane cracking in a continuous flow reactor at 1000° F. (538° C.) at an n-hexane concentration of 13 mol %. An in-line GC may be used to analyze the reactor effluent to determine the amount of hexane converted to products. The conversion of n-hexane by the catalyst relative to that produced by alumina under similar conditions provides the alpha value. A more detailed description of the “alpha value” may be found in U.S. Pat. No. 3,354,078, which is incorporated herein by reference. Additional description may be found in Journal of Catalysis, v.4, p. 527 (1965), Journal of Catalysis, v. 6, p. 278 (1966), and Journal of Catalysis, v.61, p. 390 (1980).

The terms “atomic ratio,” “mole ratio,” and “on a molar basis” are used synonymously herein.

As used herein, the term “aromatic” refers to an optionally substituted hydrocarbon compound having a cyclic cloud of pi electrons satisfying the Hackel Rule. The term “aromatic” also refers to pseudoaromatic heterocycles that have similar properties and structures (nearly planar) to hydrocarbon-based aromatic compounds, but whose pi electrons do not explicitly satisfy the Hackel Rule.

The terms “hydrocarbyl radical,” “hydrocarbyl,” and “hydrocarbyl group” are used interchangeably to refer to a hydrocarbyl compound having at least one unfilled valence position. Likewise, the terms “group,” “radical,” and “substituent” are also used interchangeably herein. The term “hydrocarbyl radical” may refer to any optionally substituted C₁-C₁₀₀ radical that may be linear, branched, or cyclic, and when cyclic, aromatic or non-aromatic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues.

As used herein, the term “ring atom” refers to an atom that is part of a cyclic ring structure. By this definition, a benzyl group has six ring atoms and tetrahydrofuran has 5 ring atoms.

The present disclosure provides the surprising discovery that bis-pyridinium compounds may serve as structure directing agents (SDAs) for synthesizing known zeolite framework structures or new zeolite framework structures. Various zeolite framework structures that are inaccessible with conventional structure directing agents may be produced using various examples of the bis-pyridinium compounds disclosed herein. Advantageously, subtle changes in the chemical structure of the SDA may be exploited to promote synthesis of different zeolite framework structures.

Bis-pyridinium compounds suitable for use as SDAs may have a structure represented by Structure 1, wherein Q is an optionally substituted C₁-C₁₀₀ hydrocarbyl group and two Q may join to form a carbocyclic ring, n is an integer ranging from 0 to 5, m is an integer ranging from 0 to 5, n+m is greater than or equal to 1, and A is a spacer group containing 2 to about 10 atoms. Preferably, both n and m are non-zero. In some embodiments, n and m are the same and are both non-zero. In some embodiments, spacer group A may comprise a linear arrangement of the 2 to about 10 atoms.

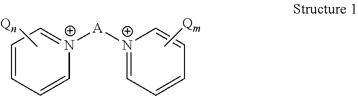

More specifically, bis-pyridinium compounds may serve as effective SDAs under hydrothermal synthesis conditions. Counteranion forms of the SDAs such as hydroxides, halides, acetates, sulfates, tetrafluoroborates, and carboxylates, for example, may be effectively used. The hydroxide form may be advantageous, however, since the hydrothermal synthesis conditions can be carried out under alkaline conditions without introducing additional quantities of alkali metal cations from an alkali metal hydroxide source. The structure of the bis-pyridinium compounds in their hydroxide counterion form is shown in Structure 2 below. Structural variants of Structure 2 are discussed below.

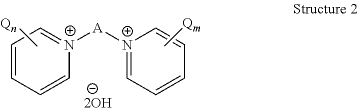

In various aspects, the present disclosure provides compositions comprising the SDAs disclosed herein. In particular, some compositions disclosed herein may comprise an at least partially crystalline network structure (or zeolite framework structure or zeolite) comprising a silicate having a plurality of pores or channels defined therein, and the bis-pyridinium compound present in at least a portion of the pores or channels. More specific examples of the SDAs and compositions obtained therefrom may include those in which the bis-pyridinium compound corresponds to Structure 1 or 2, wherein A may be (CH₂)₄, (CH₂)₅ or (CH₂)₆ or other linear arrangement of atoms.

Without being bound by any theory or mechanism, it is believed that the bis-pyridinium compounds may associate by pi-stacking, such a pi-stacked dimer, which may promote zeolite syntheses to afford synthetic advantages that may not be available with current structure directing agents, as discussed further below. The cationic portion of the bis-pyridinium compounds may become associated within the zeolite framework structure during the hydrothermal synthesis process.

A leading advantage of the bis-pyridinium compounds is that they may be removed from the zeolite framework structure via calcination without leaving behind substantial quantities of metal oxide residue. As such, it may be possible to forego a post-calcination acid treatment to remove residual metal when synthesizing zeolites according to the present disclosure. Foregoing a post-calcination acid treatment may better preserve the framework silicate in zeolite variants containing trivalent atoms, such as aluminum, since a portion of the framework silicate is no longer washed away (removed) concurrently with surface metal oxides arising from a metal-containing structure directing agent.

Another surprising and significant advantage of the bis-pyridinium compounds is that they may allow a wide range of zeolites to be synthesized with direct incorporation of trivalent atoms, such as aluminum atoms, in the framework silicate during the hydrothermal synthesis, in contrast to syntheses conducted using current structure directing agents. In some cases, framework boron atoms may be replaced with aluminum atoms. Aluminum exchange processes may introduce lower quantities of aluminum atoms than can be introduced using the direct syntheses disclosed herein. Again without being bound by any theory or mechanism, it is believed that the presence of two ionic charges that are spatially separated from one another in a pi-stacked dimer may promote more efficient incorporation of trivalent atoms than is possible when using SDA complexes bearing a single ionic charge. Tetravalent atoms such as titanium and germanium may also be directly incorporated into the framework silicate using the bis-pyridinium compounds as well.

A variety of organic reactions are available for modifying pyridine ring systems, thereby facilitating ready syntheses of structural variants of the bis-pyridinium compounds. Additional functionality may be introduced onto the pyridine ring at any position, and/or alternative alkyl groups may be introduced at any one or more of the, 2-, 3-, 4-, 5-, or 6-positions of the pyridine ring. The bis-pyridinium compounds may be symmetrical (contain the same pyridine ring substitutions) or asymmetrical (contain different pyridine ring substitutions).

Bis-pyridinium compounds (SDAs) of the present disclosure may be produced by quatemization of a substituted pyridine using a dihaloalkane, as represented in Reaction 1. Other divalent hydrocarbyl groups bearing two leaving groups, X in Reaction 1, (e.g., sulfonates) may be reacted similarly to join two pyridine rings together. Variables Q and n are defined as above.

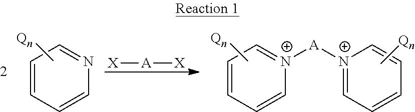

Nonlimiting examples of substituted pyridines suitable for use in the disclosure herein may include, for instance, 3,4-lutidine, 3,5-lutidine, 4-t-butylpyridine, 3-butylpyridine, 2,3,5-collidine, 2,4,6-collidine, 6,7-dihydro-5H-cyclopenta[b]pyridine, 5,6,7,8-tetrahydroquinoline, 4-phenylpyridine, and any combination thereof.

Nonlimiting examples of dihaloalkanes (or similar reagents) suitable for use in the disclosure herein may have a formula of C_{q}H_{2q}X₂, wherein q may be an integer (2, 3, 4, 5, 6, 7, 8, 9, or 10), and/or X may be Cl, Br, or I. In some cases, the dihaloalkane may have a formula of C_{q}H_{2q}X₂, in which q is 3, 4, 5, or 6, and/or X may be Cl, Br, or I. Preferably, the dihaloalkane is a straight-chain alkane, with the halide leaving groups located at the terminal carbon atoms.

Non-limiting examples of suitable bis-pyridinium compounds may include, for example:

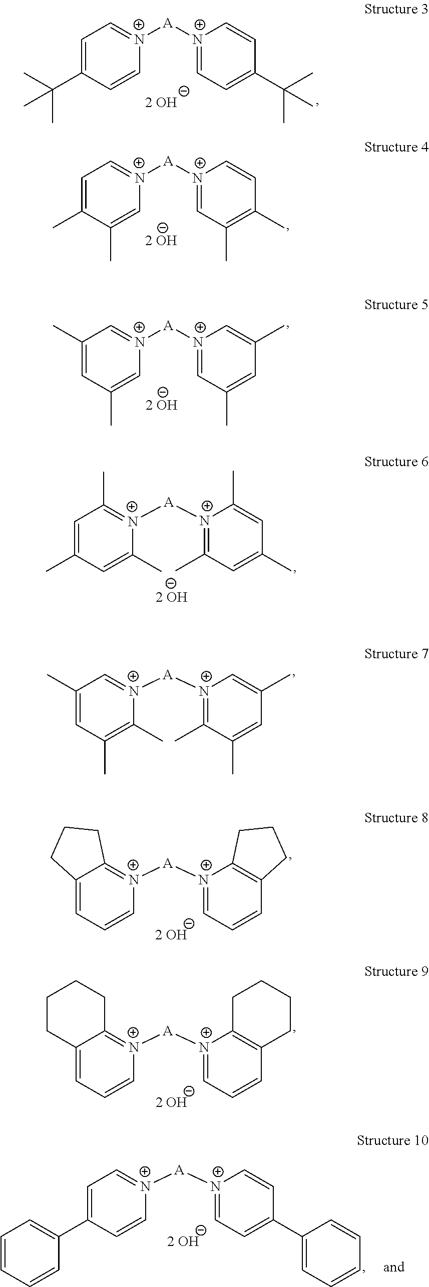

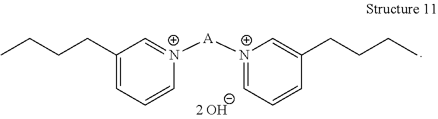

More specific examples of suitable bis-pyridinium compounds may include:

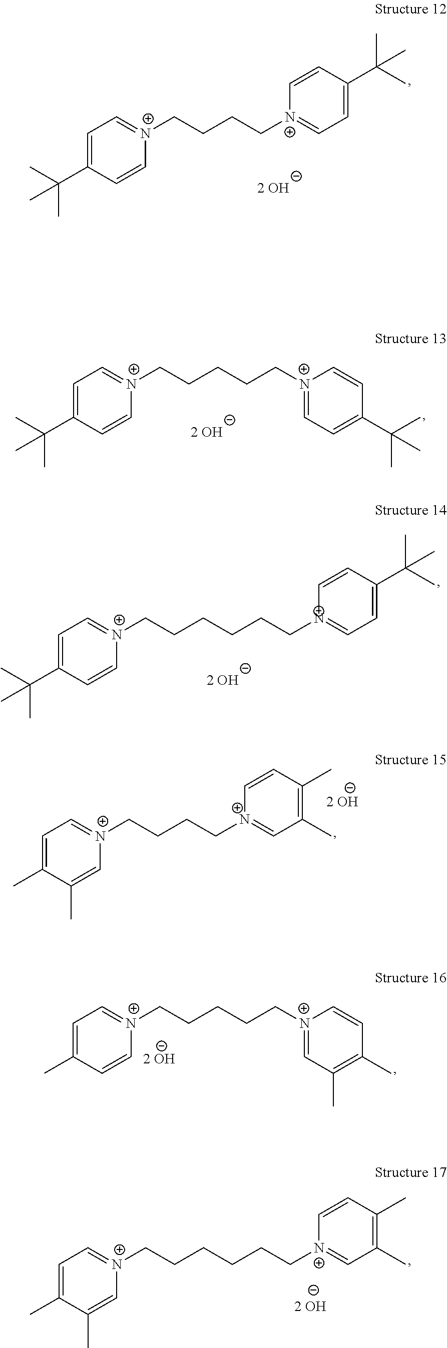

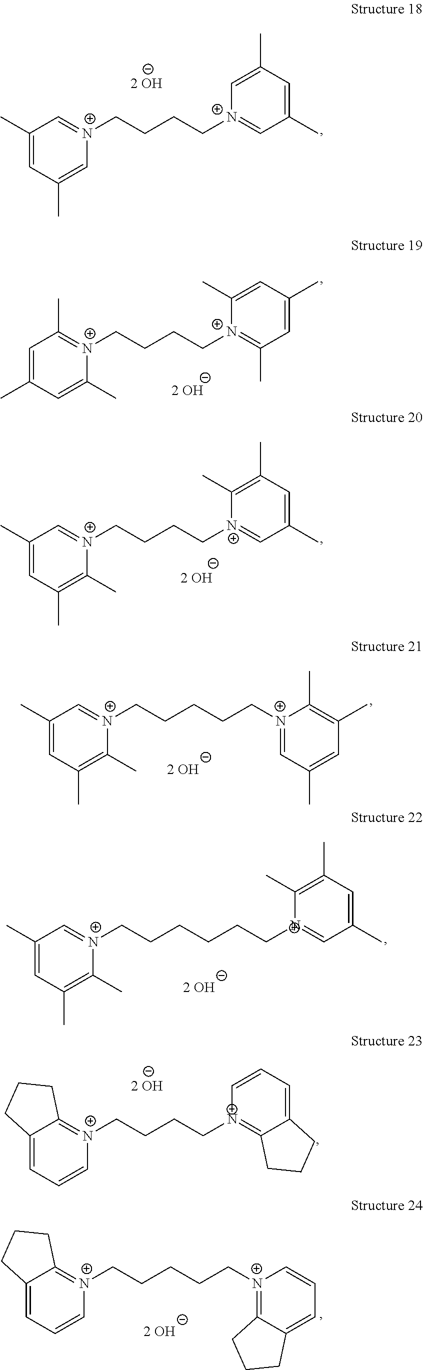

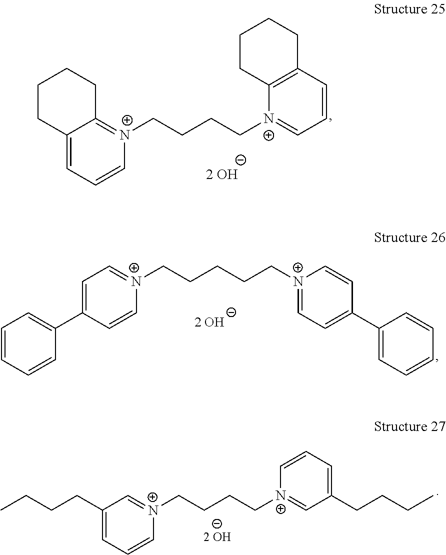 [SMILES: c1cc2c([n+](CCCC[n+]3cccc4c3CCCC4)c1)CCCC2 ; c1ccc(-c2cc[n+](CCCCC[n+]3ccc(-c4ccccc4)cc3)cc2)cc1 ; CCCCc1ccc[n+](CCCC[n+]2cccc(CCCC)c2)c1]

In a specific aspect, the present disclosure therefore relates to the use of bis-pyridinium compounds represented by Structure 1 as defined above, in particular bis-pyridinium compounds selected from the group consisting of any one of Structures 3-11, such as of any one of Structures 12-27, as a structure directing agent (SDA) for the synthesis of at least partially crystalline network structures (or zeolite framework structures or zeolites).

Accordingly, zeolite syntheses of the present disclosure may comprise: combining in an aqueous medium a silicon atom source and a bis-pyridinium compound of Structure 1; heating the aqueous medium under crystallization conditions; and obtaining an at least partially crystalline network structure (or zeolite framework structure or zeolite) from the aqueous medium. Said aqueous medium may also be referred to as “synthesis mixture”. Preferably, formation of the at least partially crystalline network structure may occur under hydrothermal synthesis conditions.

The at least partially crystalline network structure may include at least a cationic portion of the bis-pyridinium compound occluded within pores or channels of the framework silicate. Zeolites that are free of the structure directing agent may be obtained through calcination. Namely, processes of the present disclosure may include calcining the at least partially crystalline network structure in air or oxygen to remove the bis-pyridinium compound therefrom. Suitable calcination conditions may include any thermal condition that degrades the bis-pyridinium compound to form a gaseous product but without degrading the zeolite.

Hydrothermal synthesis conditions suitable for synthesizing zeolites may comprise heating the aqueous medium in a sealed container above the boiling point of water. Thus, suitable hydrothermal synthesis conditions may comprise heating a sealed aqueous solution or suspension of reactants at a temperature of at least about 100° C., or a temperature of at least about 150° C. for a period of time, such as in a range from about 100° C. to about 300° C., or from about 110° C. to about 250° C., or from about 120° C. to about 200° C., or from about 130° C. to about 180° C. The period of time may extend from about 1 day to about 30 days, or about 4 days to about 28 days, or about 4 days to about 14 days, or about 5 days to about 10 days. Accordingly, specific hydrothermal synthesis conditions may comprise heating the aqueous medium in a sealed container at a temperature of at least about 150° C., particularly about 150° C. to about 200° C., for a period of time of about 2 days or greater, particularly about 4 days to about 30 days. The aqueous medium may be sealed in a vessel, such as an autoclave vessel or ‘bomb’, in various process configurations.

In some instances, seed crystals may be included in the aqueous medium. When used, the seed crystals may be present in the aqueous medium in an amount from about 0.1 wt % to about 10 wt % relative to silicon from the silicon atom source. The seed crystals may be obtained from a previous hydrothermal synthesis of the zeolite or from a commercial source. The seed crystals may have different framework structure than that being produced under the hydrothermal synthesis conditions. Although seed crystals may facilitate crystallization of the zeolite according to the present disclosure, it is to be appreciated that the zeolite synthesis processes disclosed herein may also proceed without seed crystal use. When seed crystals are not employed, slower zeolite crystallization may be observed, in which case longer hydrothermal reaction times may be utilized. In some cases, different zeolite frameworks may be obtained using seed crystals compared to when seed crystals are not used.

The present disclosure also provides aqueous solutions comprising the bis-pyridinium compounds described above. Any suitable concentration of the bis-pyridinium compound may be present in the aqueous solution, up to the solubility limit.

The aqueous medium employed for synthesizing the zeolites may comprise an alkali metal base, an alkaline earth metal base, or an ammonium base. Alkali metal cations from the alkali metal base may promote additional incorporation of trivalent atoms, such as aluminum, in some instances. Particularly suitable alkali metal bases for use in the zeolite synthesis processes disclosed herein may include, for example, lithium hydroxide, sodium hydroxide, potassium hydroxide, or any combination thereof. Suitable alkaline earth metal bases may include, for example, strontium hydroxide and barium hydroxide. These bases will act as a source of hydroxide ions as well as sources of alkali metal, alkaline earth metal, and/or ammonium cations. Suitable amounts of the alkali (or alkaline earth) metal base may be chosen such that an atomic ratio of the alkali (or alkaline earth) metal (or hydroxide) within the alkali (or alkaline earth) metal base relative to silicon ranges from about 0.05 to about 0.5, or about 0.1 to about 0.4, or about 0.15 to about 0.35. In other instances, the aqueous medium may lack an added alkali (or alkaline earth) metal base. An alkali metal base or alkaline earth metal base may be suitably omitted when the structure directing agent is in the hydroxide counterion form.

Isolating the zeolite from the aqueous medium may comprise filtering, decanting, and/or centrifuging the aqueous medium to obtain the zeolite in solid form. Once separated from the aqueous medium, the zeolite may be washed with water or another suitable fluid to remove impurities remaining from the hydrothermal synthesis. The bis-pyridinium compound remains associated with framework silicate at this juncture and is not substantially removed during washing. Excess SDA that does not become occluded within the framework silicate during the hydrothermal synthesis may be removed during washing at this juncture.

The zeolite synthesis processes of the present disclosure may further comprise calcining the zeolite in air or oxygen to form a calcined zeolite that is free or substantially free of the bis-pyridinium compound. Suitable calcination temperatures may range from about 300° C. to about 1000° C., or about 400° C. to about 700° C., or about 450° C. to about 650° C. Calcination may oxidize the bis-pyridinium compound into gaseous products which then exit the framework silicate of the zeolite. The framework silicate of the zeolite may be substantially unaffected by the calcination process, as evidenced by characteristic scattering angles of the powder x-ray diffraction spectrum remaining largely unchanged between the pre-calcination zeolite and the post-calcination zeolite. Suitable calcination times may range from about 1 hour to about 48 hours, or even longer.

The zeolite syntheses of the present disclosure may be used to synthesize the framework silicate of known or unknown zeolites containing only silicon atoms and oxygen atoms. Alternately, a trivalent atom and/or a tetravalent atom may replace at least a portion of the silicon atoms in the framework silicate. The trivalent and/or tetravalent atoms may be introduced directly under the hydrothermal synthesis conditions. Accordingly, the zeolite syntheses of the present disclosure may further comprise combining at least one of a trivalent atom source or a tetravalent atom source with the silicon atom source and the bis-pyridinium compound (SDA) in the aqueous medium employed in the zeolite synthesis processes. Trivalent atoms that may be incorporated include, for example, boron, gallium, iron, and aluminum. Tetravalent atoms that may be incorporated include, for example, germanium, tin, titanium, and vanadium. Divalent atoms such as zinc and pentavalent elements such as phosphorus may also be suitably incorporated.

In some or other instances, zeolite syntheses of the present disclosure may be performed using one or more fluoride compounds as the source of atoms comprising the zeolite. For example, zeolite syntheses of the present disclosure may be carried out by combining a silica source (e.g., TMOS) with the hydroxide form of an SDA source, followed by addition of a fluoride compound, to form a suspension. One or more sources of boron and/or aluminum may also be added. Non-limiting examples of fluoride compounds suitable for use in the disclosure herein may include, for instance, hydrogen fluoride, ammonium fluoride, hydrofluoric acid, and any combination thereof.

The zeolite syntheses of the present disclosure may therefore comprise: (a) combining in an aqueous medium (or synthesis mixture) at least water, a silicon atom source, a bis-pyridinium compound of Structure 1 (such as of any one of Structures 3 to 11, or of any one of Structures 12 to 27), optionally a source of hydroxide ions, and optionally a source of alkali and/or alkaline earth metal element; (b) heating said aqueous medium under crystallization conditions including a temperature of from 100° C. to 200° C. for a time sufficient to form the zeolite; and (c) recovering at least a portion of the zeolite from the aqueous medium of step (b). The aqueous medium (or synthesis mixture) of step (a) may optionally further comprise at least one of a source of trivalent atoms, e.g., selected from the group consisting of boron, gallium, iron, aluminum, and mixtures thereof (in particular boron and/or aluminum), and/or a source of tetravalent atoms, e.g., selected from the group consisting of germanium, titanium and/or vanadium (in particular germanium).

The at least partially crystalline network structure of the zeolite produced according to the disclosure herein may have a framework type selected from the group consisting of MTW, Beta, NES, IMF, BEA, STW, PST-22, IZM-2, UZM-55, COK-5, EMM-17, EMM-69, and EMM-XY, as characterized powder x-ray diffraction. EMM-69 and EMM-XY are not believed to have been produced previously and are characterized in further detail below.

In non-limiting examples, the bis-pyridinium compound of Structure 12 may be suitable for forming zeolites Beta, NES, MTW, ANA, MOR, and any combination thereof (e.g., zeolites having a composition mixture of NES/MTW/ANA, or NES/MOR) under appropriate hydrothermal synthesis conditions.

In non-limiting examples, the bis-pyridinium compound of Structures 13 and 14 may be suitable for forming zeolite Beta under appropriate hydrothermal synthesis conditions.

In non-limiting examples, the bis-pyridinium compound of Structure 15 may be suitable for forming zeolites EMM-69, MFI, STW, MTW, and any combination thereof under appropriate hydrothermal synthesis conditions.

In non-limiting examples, the bis-pyridinium compound of Structure 16 may be suitable for forming zeolites NES, IZM-2, and any combination thereof under appropriate hydrothermal synthesis conditions.

In non-limiting examples, the bis-pyridinium compound of Structure 17 may be suitable for forming zeolites EMM-69, NES, MTW, MFI, EMM-17, ZSM-12, and any combination thereof (e.g., zeolites having a composition mixture of EMM-69/MFI, or EMM-17/MTW) under appropriate hydrothermal synthesis conditions.

In non-limiting examples, the bis-pyridinium compound of Structure 18 may be suitable for forming zeolites EMM-XY, PST-22, MWT, ANA, borosilicate zeolites, and any combination thereof under appropriate hydrothermal synthesis conditions. In some instances, zeolites formed using the bis-pyridinium compound of Structure 18 may comprise quartz.

In non-limiting examples, the bis-pyridinium compound of Structure 19 may be suitable for forming zeolite STW under appropriate hydrothermal synthesis conditions.

In non-limiting examples, the bis-pyridinium compound of Structure 20 may be suitable for forming zeolites STW, PST-22, and any combination thereof under appropriate hydrothermal synthesis conditions.

In non-limiting examples, the bis-pyridinium compound of Structure 21 may be suitable for forming zeolite PST-22 under appropriate hydrothermal synthesis conditions. In some instances, zeolites formed using the bis-pyridinium compound of Structure 21 may comprise quartz.

In non-limiting examples, the bis-pyridinium compound of Structure 22 may be suitable for forming zeolite ATS or aluminophosphate-based zeotype materials under appropriate hydrothermal synthesis conditions.

In non-limiting examples, the bis-pyridinium compound of Structure 23 may be suitable for forming zeolite STW under appropriate hydrothermal synthesis conditions.

In non-limiting examples, the bis-pyridinium compound of Structure 24 may be suitable for forming zeolite STW under appropriate hydrothermal synthesis conditions.

In non-limiting examples, the bis-pyridinium compound of Structure 25 may be suitable for forming zeolite STW under appropriate hydrothermal synthesis conditions.

In non-limiting examples, the bis-pyridinium compound of Structure 26 may be suitable for forming zeolite ZSM-12 under appropriate hydrothermal synthesis conditions.

In non-limiting examples, the bis-pyridinium compound of Structure 27 may be suitable for forming zeolites UZM-15, FU-1, and any combination thereof under appropriate hydrothermal synthesis conditions.

PST-22 zeolites produced using a bis-pyridinium compound according to the disclosure herein may have a post-calcination powder x-ray diffraction pattern with at least the following 2θ scattering angles (±0.20): 9.95, 11.18, 15.31, 18.34, 22.59, 23.31, and 26.57, optionally a plurality of peaks among 9.95, 11.18, 15.31, 18.34, 22.59, 23.31, 24.10, 24.97, 26.57, 28.45, 29.66, and 34.88, as determined using Cu Kα radiation.

EMM-69 zeolites produced using a bis-pyridinium compound according to the disclosure herein may have a post-calcination powder x-ray diffraction pattern with at least the following 20 scattering angles (±0.20): 7.13, 10.36, 15.04, 22.99 and 23.46, optionally a plurality of peaks among 6.36, 7.13, 9.15, 10.36, 15.04, 16.09, 18.73, 20.95, 22.99, 23.46, 26.12, 28.55, 31.47, and 37.35.

EMM-XY zeolites produced using a bis-pyridinium compound according to the disclosure herein may have a post-calcination powder x-ray diffraction pattern with at least the following 20 scattering angles (±0.20): 7.04, 7.49, 9.03, 22.86, and 23.33, optionally a plurality of peaks among 6.25, 7.04, 7.49, 9.03, 10.29, 15.10, 19.38, 20.80, 22.86, 23.33, 25.47, 28.50, 31.30, and 37.39.

It is to be appreciated that the 2θ peak positions described above are approximate and may vary to some degree (e.g., ±0.20 degrees) depending on sample placement, instrument limitations, and other factors. Minor variations in the powder x-ray diffraction pattern (e.g., experimental variation in peak ratios and peak positions) can also result from variations in the atomic ratios of the framework atoms due to changes in lattice constants. In addition, sufficiently small crystals may affect the shape and intensity of peaks, possibly leading to peak broadening. Calcination can also cause minor shifts in the powder x-ray diffraction pattern compared to the pre-calcination powder x-ray diffraction pattern. Notwithstanding these minor perturbations, the crystal lattice structure may remain unchanged following calcination.

Zeolites disclosed herein may be pre-calcination (non-calcined) zeolites or post-calcination (calcined) zeolites, with a cationic portion of the directing agent of Structure 1 or 2 being present in the former and absent or substantially absent from the latter. When present, the cationic portion of the directing agent is occluded within pores or channels of the zeolite.

Silica, including various forms thereof, may be a suitable silicon atom source in the zeolite synthesis processes disclosed herein. More specific forms of silica that may be suitably used include, for example, precipitated silica, fumed silica, silica hydrogels, colloidal silica, hydrated silica, or any combination thereof. The silica may be suspended in the aqueous medium prior to being exposed to the hydrothermal synthesis conditions disclosed herein. Alternative silicon atom sources suitable for use according to the disclosure herein may include, for example, tetramethylorthosilicate, tetraethylorthosilicate or other tetraalkylorthosilicates, sodium silicate, silicic acid, other zeolites, and similar compounds.

Suitable trivalent atoms for incorporation in the framework silicate of the zeolites may include boron, gallium, iron, or aluminum, for example. Suitable tetravalent atoms for incorporation in the framework silicate of the zeolites may include group 14 atoms (e.g., germanium) and/or transition metals (e.g., titanium or vanadium). As mentioned above, the zeolite synthesis processes of the present disclosure may be particularly advantageous due to their ability to incorporate aluminum atoms and other trivalent atoms in the framework silicate of the zeolite directly, rather than having to perform a post-synthesis exchange of aluminum for boron, for example. Alternately, however, post-synthesis exchange of aluminum for boron may be employed to introduce aluminum atoms into the framework silicate of the zeolite synthesized according to the present disclosure, as discussed further herein below.

Certain variants of the zeolites may comprise a framework silicate incorporating boron atoms. Borate salts (e.g., sodium tetraborate or borax, potassium tetraborate) or boric acid may be suitable trivalent atom sources for incorporating boron atoms into the framework silicate of the zeolite according to the present disclosure. The borate salts or boric acid may be suspended or at least partially dissolved in the aqueous medium prior to being exposed to the hydrothermal synthesis conditions disclosed herein. When boron is incorporated in the framework silicate of the zeolite according to the present disclosure, the zeolite may have a Si:B atomic ratio of about 150:1 to about 5:1, 100:1 to about 5:1, or about 100:1 to about 10:1, or about 60:1 to about 10:1, or about 50:1 to about 15:1, or about 40:1 to about 20:1, or about 50:1 to about 5:1, or about 40:1 to about 5:1, or about 30:1 to about 5:1, or about 20:1 to about 5:1. For example, the zeolite may have a Si:B atomic ratio of about 2 to about 50, such as about 5 to about 40, such as about 10 to about 30.

Certain variants of the zeolites may comprise a framework silicate incorporating titanium atoms. Titanium dioxide may be a suitable tetravalent atom source for incorporating titanium atoms into the framework silicate of the zeolite. Alternately, titanium tetraalkoxides, such as titanium (IV) tetraethoxide, or titanium (IV) tetrachloride may be suitable titanium atom sources. The titanium dioxide may be suspended or gelled in the aqueous medium prior to being exposed to the hydrothermal synthesis conditions disclosed herein. When titanium is incorporated in the framework silicate of the zeolite according to the present disclosure, the zeolite may have a Si:Ti atomic ratio of about 100:1 to about 30:1, or about 80:1 to about 35:1, or about 70:1 to about 40:1, or about 50:1 to about 30:1.

Certain variants of the zeolites may comprise a framework silicate incorporating aluminum atoms. Alumina, including various forms thereof, may be a suitable trivalent atom source for incorporating aluminum atoms into the framework silicate of the zeolite. Other suitable aluminum atom sources may include, for example, hydrated alumina, aluminum hydroxide, clay (e.g., metakaolin clay), aluminum nitrate, aluminum sulfate, aluminates, or other zeolites. The alumina or alternative source of aluminum atoms may be suspended or gelled in the aqueous medium prior to being exposed to the hydrothermal synthesis conditions disclosed herein. When aluminum is incorporated in the framework silicate of the zeolite according to the present disclosure, the zeolite may have a Si:Al atomic ratio of about 150:1 to about 30:1, or about 100:1 to about 35:1, or about 80:1 to about 35:1, or about 70:1 to about 40:1, or about 30:1 to about 10:1, or about 20:1 to about 10:1, or about 15:1 to about 10:1, or about 10:1 to about 5:1. Particular embodiments may include variants of the zeolite in which the Si:Al atomic ratio is less than about 15:1, particularly ranging from about 15:1 to about 5:1. For example, the zeolite may have a Si:Al atomic ratio of about 2 to about 50, such as about 5 to about 40 or about 10 to about 40.

Certain variants of the zeolites may comprise a framework silicate incorporating germanium atoms. Germanium oxide, germanium chloride, germanium isopropoxide, and sodium germinate may be a suitable tetravalent atom source for incorporating germanium atoms into the framework silicate of the zeolites. The germanium source may be suspended or gelled in the aqueous medium prior to being exposed to the hydrothermal synthesis conditions disclosed herein. When germanium is incorporated in the framework silicate of the zeolite according to the present disclosure, the zeolite may have a Si:Ge atomic ratio of about 100:1 to about 5:1, or about 100:1 to about 10:1, or about 90:1 to about 15:1, or about 80:1 to about 20:1, or about 80:1 to about 30:1, or about 70:1 to about 40:1, or about 50:1 to about 30:1. For example, the zeolite may have a Si:Ge atomic ratio of about 2 to about 10, such as about 3 to about 9 or about 4 to about 8.

Two or more sources of trivalent atoms and/or tetravalent atoms may be incorporated in the zeolite synthesis processes disclosed herein. For example, zeolites synthesized using the zeolite synthesis processes of the present disclosure may feature a framework silicate comprising boron and aluminum, boron and titanium, or aluminum and titanium, or aluminum and germanium, or other various combinations of trivalent and tetravalent atoms. Ternary combinations of boron, aluminum, germanium, and titanium are also within the scope of the present disclosure. Other higher-level combinations of trivalent and tetravalent atoms also reside within the scope of the present disclosure. When two or more sources of trivalent atoms and/or tetravalent atoms are used, the atomic ratio of silicon to the sum of the atomic ratios of the two or more sources of trivalent and/or tetravalent atoms (e.g., the sum of the atomic ratios of boron, aluminum and any other alternative atoms) may range from about 100:1 to about 10:1, or about 100:1 to about 15:1, or about 100:1 to about 30:1.

Likewise, the atomic ratio of the bis-pyridinium compound to silicon in the aqueous medium may vary over a wide range in the zeolite synthesis processes disclosed herein. In non-limiting examples, suitable ratios of the SDA to silicon may range from about 0.2:1 to about 0.4:1.

As mentioned above, the zeolite synthesis processes of the present disclosure may be advantageous due to their ability to incorporate aluminum directly into the framework silicate of the zeolite during a hydrothermal synthesis reaction. Alternately, aluminum atoms may be introduced to the framework silicate during an exchange process following a hydrothermal synthesis reaction. Framework silicates comprising boron atoms may be particularly efficacious for undergoing exchange with aluminum atoms. Such exchange processes may comprise exposing the zeolite to an aqueous solution comprising an aluminum salt, and exchanging at least a portion of the boron atoms in the framework silicate with aluminum atoms from the aluminum salt in the aqueous solution. Suitable aluminum salts may exhibit at least some degree of solubility in water or other suitable aqueous media. Particularly suitable aluminum salts for exchanging aluminum atoms into the framework silicate in this manner may include, for example, aluminum chloride, aluminum acetate, aluminum sulfate, and aluminum nitrate.

Accordingly, pre-calcination (non-calcined) zeolites produced in accordance with the disclosure above may comprise: a composition comprising: an at least partially crystalline network structure comprising a silicate having a plurality of pores or channels defined therein; a bis-pyridinium compound present in at least a portion of the pores or channels; and wherein the at least partially crystalline network structure exhibits an XRD pattern.

The pre-calcination zeolites may have a silicate framework containing substantially silicon atoms and oxygen atoms, which may be referred to as “all silica” zeolites herein. Alternately, the silicate framework may incorporate aluminum atoms, such that the zeolite has a Si:Al atomic ratio of about 10 or greater, such as an atomic ratio of about 100:1 to about 10:1. Further alternately or in addition to aluminum incorporation, the silicate framework may incorporate germanium atoms, such that the zeolite has a Si:Ge atomic ratio of about 100:1 to about 30:1. Still further alternately or in addition to aluminum and/or germanium incorporation, the silicate framework may incorporate boron atoms, such that the zeolite has a Si:B atomic ratio of about 100:1 to about 10:1 or about 5:1.

Post-calcination (calcined) zeolites produced in accordance with the disclosure above may comprise: a composition comprising: an at least partially crystalline network structure comprising a silicate having a plurality of pores or channels defined therein, wherein the at least partially crystalline network structure is characterized by an XRD pattern having the following two-theta values (20 scattering angles), as determined using CuK-α radiation.

### Embodiments Disclosed Herein Include

A. Compositions comprising a zeolite framework containing a bis-pyridinium compound. The compositions comprise: an at least partially crystalline network structure comprising a silicate having a plurality of pores or channels defined therein; and a bis-pyridinium compound present in at least a portion of the pores or channels, the bis-pyridinium compound having a structure represented by:

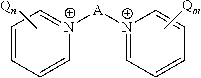

wherein Q is an optionally substituted C₁-C₁₀ hydrocarbyl group and two Q may join to form a carbocyclic ring, n is an integer ranging from 0 to 5, m is an integer ranging from 0 to 5, n+m is greater than or equal to 1, and A is a spacer group containing 2 to about 10 atoms.

B. Zeolite frameworks. The zeolite frameworks comprise an at least partially crystalline network structure comprising a silicate having a plurality of pores or channels defined therein, prepared by a process comprising: combining in an aqueous medium a silicon atom source and a bis-pyridinium compound having a structure represented by:

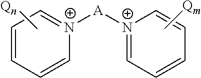

wherein Q is an optionally substituted C₁-C₁₀ hydrocarbyl group and two Q may join to form a carbocyclic ring, n is an integer ranging from 0 to 5, m is an integer ranging from 0 to 5, n+m is greater than or equal to 1, and A is a spacer group containing 2 to about 10 atoms; heating the aqueous medium under crystallization conditions; obtaining the at least partially crystalline network structure from the aqueous medium; and calcining the at least partially crystalline network structure in air or oxygen to remove the bis-pyridinium compound from the at least partially crystalline network structure; wherein the at least partially crystalline network structure has a framework type selected from the group consisting of EMM-69 and EMM-XY.

C. Processes for making zeolite frameworks with a bis-pyridinium compound as an SDA. The processes comprise: combining in an aqueous medium a silicon atom source and a bis-pyridinium compound having a structure represented by:

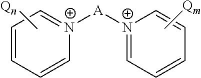

wherein Q is an optionally substituted C₁-C₁₀ hydrocarbyl group and two Q may join to form a carbocyclic ring, n is an integer ranging from 0 to 5, m is an integer ranging from 0 to 5, n+m is greater than or equal to 1, and A is a spacer group containing 2 to about 10 atoms; heating the aqueous medium under crystallization conditions; and obtaining an at least partially crystalline network structure from the aqueous medium.
Embodiments A-C May have One or More of the Following Additional Elements in any Combination:
Element 1: wherein A is (CH₂)₄, (CH₂)₅ or (CH₂)₆.
Element 2: wherein the bis-pyridinium compound has a structure selected from the group consisting of

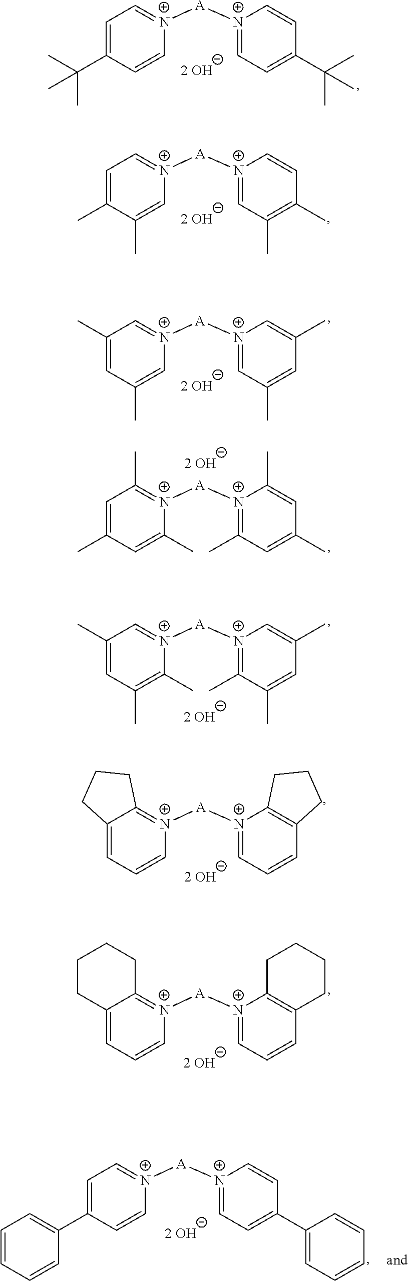

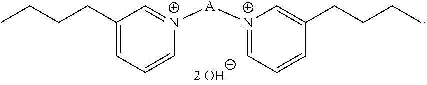

Element 3: wherein the bis-pyridinium compound has a structure selected from the group consisting of

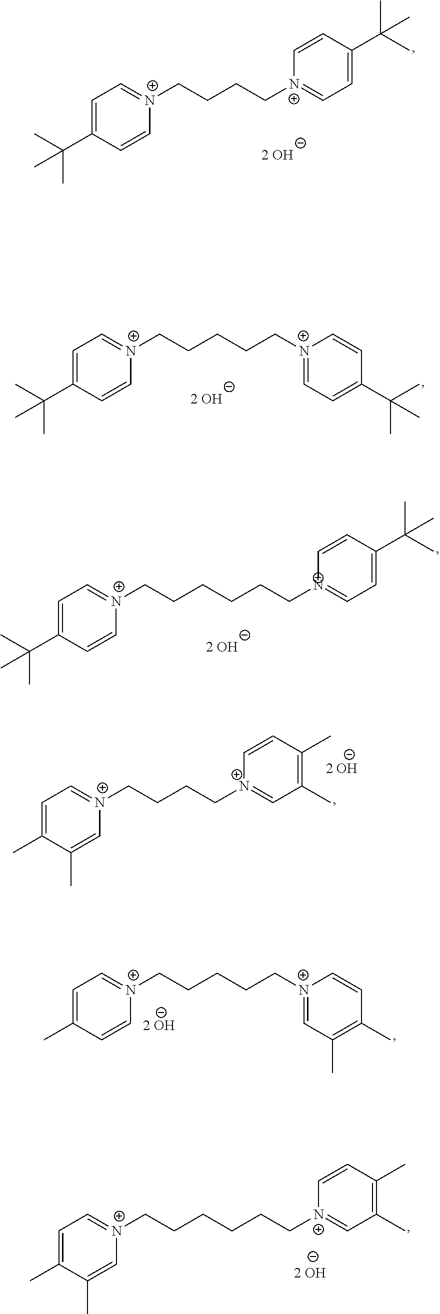

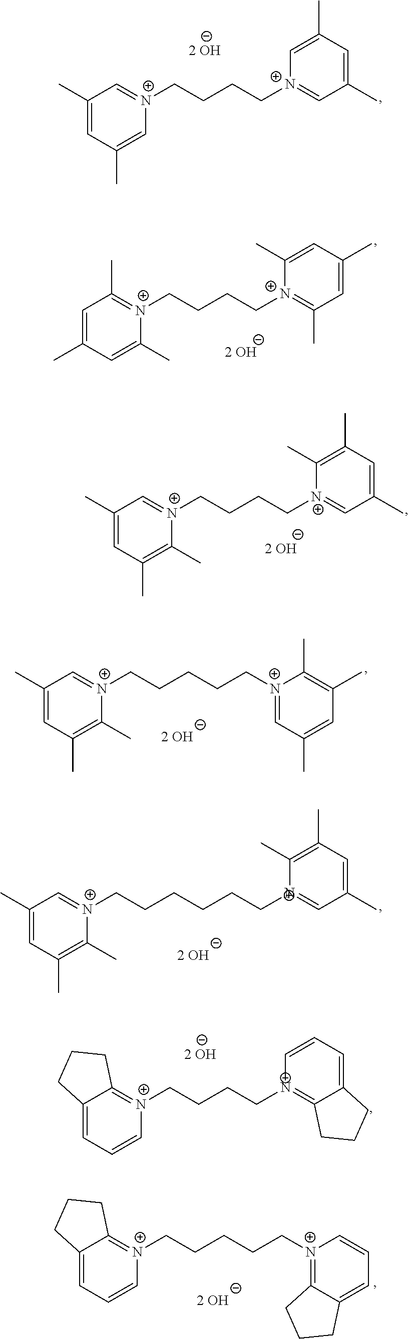

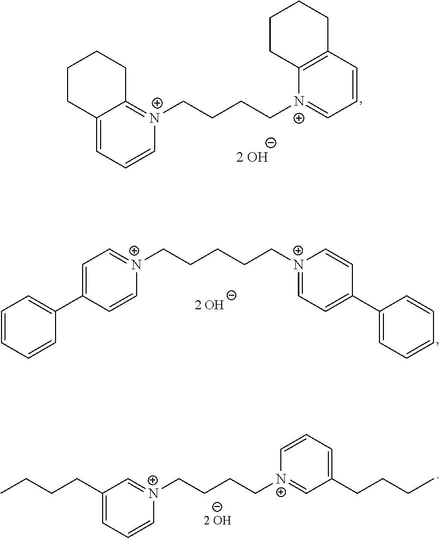 [SMILES: c1cc2c([n+](CCCC[n+]3cccc4c3CCCC4)c1)CCCC2 ; c1ccc(-c2cc[n+](CCCCC[n+]3ccc(-c4ccccc4)cc3)cc2)cc1 ; CCCCc1ccc[n+](CCCC[n+]2cccc(CCCC)c2)c1]

Element 4: wherein the at least partially crystalline network structure comprises a trivalent element selected from the group consisting of B, Al, Fe, Ga, and any combination thereof.
Element 4A: wherein a trivalent element source is present in the aqueous medium, the trivalent metal being selected from the group consisting of B, Al, Fe, Ga, and any combination thereof.
Element 5: wherein the at least partially crystalline network structure comprises a tetravalent element selected from the group consisting of Ge, Sn, Ti, and any combination thereof
Element 5A: wherein a tetravalent element source is present in the aqueous medium, the tetravalent element being selected from the group consisting of Si, Ge, Sn, Ti, and any combination thereof.
Element 6: wherein the at least partially crystalline network structure comprises a pentavalent element, the pentavalent element being phosphorus.
Element 6A: wherein a pentavalent element source is present in the aqueous medium, the pentavalent element being phosphorus.
Element 7: wherein the at least partially crystalline network structure has a Si:Al atomic ratio of about 10 or greater.
Element 8: wherein the at least partially crystalline network structure has a Si:B atomic ratio of about 10 or greater.
Element 9: wherein the process further comprises calcining the at least partially crystalline network structure in air or oxygen to remove the bis-pyridinium compound from the at least partially crystalline network structure.
Element 10: wherein the at least partially crystalline network structure has a framework type selected from the group consisting of PST-22, EMM-17, EMM-69, and EMM-XY.
Element 10A: wherein the at least partially crystalline network structure has a framework type selected from the group consisting of EMM-69, and EMM-XY.

By way of non-limiting example, illustrative combinations applicable to A-C include, but are not limited to, 1, 2 or 3, and 4 or 4A; 1, 2 or 3, and 5 or 5A; 1, 2 or 3, and 6 or 6A; 1, 2 or 3, 4 or 4A, and 5 or 5A; 1, 2 or 3, 4 or 4A, and 6 or 6A; 1, 2 or 3, 5 or 5A, and 6 or 6A; 1, 2 or 3, 4 or 4A, 5 or 5A, and 6 or 6A; 1, 2 or 3, and 7; 1, 2 or 3, and 8; 1, 2 or 3, and 10 or 10A; 4 or 4A, and 7; 4 or 4A, and 8; 4 or 4A, and 10; 5 or 5A, and 7; 5 or 5A, and 8; 5 or 5A, and 10; 6 or 6A, and 7; 6 or 6A, and 8; 6 or 6A, and 10 or 10A; 4 or 4A, 5 or 5A, and 6 or 6A; 4 or 4A, 5 or 5A, and 7; 4 or 4A, 5 or 5A, and 8; 4 or 4A, 5 or 5A, and 10 or 10A; 5 or 5A, 6 or 6A, and 7; 5 or 5A, 6 or 6A, and 8; 5 or 5A, 6 or 6A, and 10; 6 or 6A, and 7; 6 or 6A, and 8; 6 or 6A, and 10 or 10A; 4 or 4A, 5 or 5A, 6 or 6A, and 7; 4 or 4A, 5 or 5A, 6 or 6A, and 8; 4 or 4A, 5 or 5A, 6 or 6A, and 10 or 10A; 7 and 10; and 8 and 10 or 10A.

To facilitate a better understanding of the embodiments of the present disclosure, the following examples of preferred or representative embodiments are given. In no way should the following examples be read to limit, or to define, the scope of the invention.

### Examples

Powder x-ray diffraction (XRD) analyses of each sample were obtained with a Bruker D4 ENDEAVOR instrument operating in continuous mode using Cu Kα radiation, a step size of 0.01796 degrees, and a VANTEC-1™ gaseous detector having a 50 mm×16 mm active area or with a Bruker DAVINCI D8 DISCOVER instrument operating in continuous mode using Cu Kα radiation and a VÅNTEC-500™ detector in Bragg-Bentano geometry. Interplanar spacings, also referred to as “d-spacings”, were calculated in angstrom units. The relative intensity of the lines, I/I(o), is the ratio of the peak intensity to that of the intensity of the strongest peak above background. The intensities are uncorrected for Lorentz and polarization effects. The location of the diffraction peaks in 2-theta (2θ scattering angles), and the relative peak area intensities of the lines, I/I(o), were determined with the MDI JADE peak search algorithm. It should be understood that diffraction data listed as single lines may consist of multiple overlapping lines that under certain conditions, such as differences in crystallographic changes, may appear as resolved or partially resolved lines. Typically, crystallographic changes can include minor changes in unit cell parameters and/or a change in crystal symmetry, without a change in the overall structure. Such minor effects, including changes in relative intensities, can also occur as a result of differences in cation content, framework composition, nature and degree of pore filling, crystal size and shape, preferred orientation and thermal and/or hydrothermal history.

Silica precursors used forming zeolites in the examples below included LUDOX® LS-30 (L), AERODISP® W7330 N (A), or tetraalkyl orthosilicates such as tetramethylorthosilicate (TMOS) or tetraethylorthosilicate (TEOS). Sodium aluminate (8.826 wt % NaAlO₂, S), potassium aluminate (K), zeolite Y (Si/Al=3, Y), metakaolin (MK), aluminum isopropoxide (iso) and MS-25 CATAPAL® A SASOL (65.5% silica-22% alumina) were used as alumina sources. Boric acid (B) was used as a boron source. 20% HF was used as a fluoride source. Germanium oxide was used as a germanium source.

In the Tables below, T represents a trivalent or tetravalent element.

### General Synthesis of the Bis-Pyridinium Compounds

A substituted pyridine (e.g., 3,4-lutidine; 3,5-lutidine; 4-t-butylpyridine; 3-butylpyridine; 2,3,5-collidine; 2,4,6-collidine; 6,7-dihydro-5H-cyclopenta[b]pyridine; 5,6,7,8-tetrahydroquinoline; or 4-phenylpyridine) was quaternized to form the corresponding bis-pyridinium compound by mixing the substituted pyridine (0.222 mol) with 50 mL acetonitrile, followed by the addition of a dihaloalkane (0.101 mol) (e.g., 1,4-dibromobutane; 1,5-dibromopentane; or 1,6-dibromohexane). After heating the mixture in a sealed 125-mL Parr autoclave Teflon vessel at 80° C. for 24 hours, the solid product was isolated by filtration, and washed with acetone and then diethyl ether. The solid product was dried at ambient temperature to provide the product as a dibromide salt. The product was determined to be pure by ¹³C and ¹H NMR. The product was then dissolved in deionized water and exchanged into the hydroxide form by addition of a three-fold excess of DOWEX® Monosphere 550A ion-exchange resin.

### General Procedure for High-Throughput Zeolite Synthesis Screening Reactions Using Bis-Pyridinium Compounds

The bis-pyridinium compound (SDA) was provided as an aqueous solution for a series of high-throughput zeolite synthesis screening reactions. For illustrative high-throughput zeolite synthesis screening reactions, a 15 wt % aqueous silica suspension (e.g., LUDOX® LS-30 or AERODISP® W7330 N) was combined with an aqueous base solution (15 wt % to 30 wt % NaOH) and the aqueous solution of the bis-pyridinium compound. Reactions using different reagents may be conducted similarly. Reactant ratios, bis-pyridinium compound aqueous solution concentrations, and further reaction parameters are specified in the specific examples below.

### General Procedure for Calcination

Unless otherwise specified, calcination was conducted in a box furnace by first exposing the sample to flowing nitrogen atmosphere for 2 hours at room temperature, and the temperature was then ramped over two hours to 400° C. under nitrogen atmosphere. The temperature was held at 400° C. for 15 minutes before replacing the flowing nitrogen atmosphere for flowing dried air. The temperature was then ramped from 400° C. to 600° C. over one hour and held at 600° C. for 2-16 hours before cooling.

### Example 1: 1,1′-(butane-1,4-diyl)bis(4-(tert-butyl)pyridin-1-ium) dihydroxide (Structure 12)

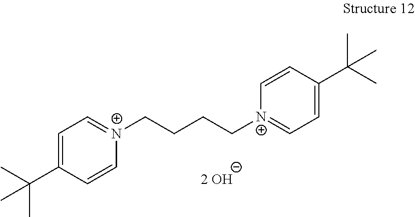 [SMILES: CC(C)(C)c1cc[n+](CCCC[n+]2ccc(C(C)(C)C)cc2)cc1]

The bis-pyridinium compound (Structure 12) was prepared following the general procedure described above using 4-t-butylpyridine and 1,4-dibromobutane. A 10.6 wt % aqueous solution was utilized for the zeolite syntheses below.

### High-Throughput Beta Zeolite Synthesis Screening Reactions Using Structure 12

Pre-synthesis ratios of the reactants, reaction temperatures, and reaction times for various samples are specified in Table 1 below. The characterization results in Table 1 are based upon analysis of the powder XRD pattern of the products in comparison to a known sample (XRD results not shown). Beta zeolite was obtained in each case.

TABLE 1

| Sample | SDA:Si | H₂O:T⁺⁴ | Si: T^{+3,4} | MOH:Si | Silica |
|---|---|---|---|---|---|
| No. | (atomic) | (atomic) | (atomic) | (atomic) | Source |
| 1 | 0.15 | 37 | T = Al, 40 | M = Na, 0.15 | L |
| 2 | 0.15 | 37 | T = Al, 20 | M = Na, 0.30 | L |
| 3 | 0.15 | 37 | T = Al, 20 | M = Na, 0.30 | L |
| Sample | T⁺³ | HCl:Si | Temperature | Reaction Time | |
| No. | Source | (atomic) | (° C.) | (days) | Result |
| 1 | S | 0 | 120 | 28 | Beta, broad |
| 2 | Y | 0 | 120 | 28 | Beta, broad |
| 3 | MK | 0 | 120 | 28 | Beta, broad |

### High-Throughput NES Zeolite Synthesis Screening Reactions Using Structure 12

Pre-synthesis ratios of the reactants, reaction temperatures, and reaction times for various samples are specified in Table 2 below. The characterization results in Table 2 are based upon analysis of the powder XRD pattern of the products in comparison to a known sample (XRD results not shown). NES zeolite was obtained in each case.

TABLE 2

| Sample | SDA:Si | | | Si:T^{+3,4} | Silica |
|---|---|---|---|---|---|
| No. | (atomic) | H₂O:Si (atomic) | | (atomic) | Source |
| 4 | 0.25 | 4 | | T = B, 40 | TMOS |
| 5 | 0.25 | 10 | | All-silica | TMOS |
| 6 | 0.25 | 10 | | T = Al, 50 | TMOS |
| 7 | 0.25 | 4 | | T = Al, 50 | TMOS |
| 8 | 0.25 | 10 | | T = B, 5 | TMOS |
| | | | | Reaction | |
| Sample | T³⁺ | F:Si | Temperature | Time | |
| No. | Source | (atomic) | (° C.) | (days) | Result |
| 4 | B | 0.5 | 175 | 7 | 50% NES, 50% layered |
| 5 | — | 0.5 | 175 | 7 | NES, trace layered |
| 6 | iso | 0.5 | 175 | 7 | NES, trace layered |
| 7 | iso | 0.5 | 175 | 7 | NES, minor layered |
| 8 | B | 0.5 | 175 | 7 | NES, layered |

### NES Zeolite Synthesis Scale-up Using Structure 12

3.08 g of the bis-pyridinium compound (Structure 12), 0.72 g of 1 N NaOH, 4.54 g of deionized water, 0.036 g of sodium tetraborate decahydrate, and 0.54 g of CAB-O-SIL® M-5 fumed silica were mixed together in a 23 mL Parr reactor in a Teflon liner. The reactor was heated at 160° C. for 10 days under tumbling conditions (approximately 30 rpm). The product was isolated by filtration and rinsed with deionized water. Power XRD (not shown) indicated that the zeolite product was a NES phase.

### Alternate NES Zeolite Synthesis Scale-up Using Structure 12

The previous NES zeolite scale-up synthesis was repeated under modified conditions by using Alcoa-C₃₁ as an alumina source in order to adjust the Si:Al atomic ratio to 150 while maintaining the Si:B atomic ratio at about 22:1. Powder XRD (not shown) again indicated that a pure NES phase was obtained.

### Mixture of NES/MTW/ANA Zeolite Under Scale-up Conditions Using Structure 12

3.47 g of the bis-pyridinium compound (Structure 12), 1.80 g of 1 N NaOH, 1.17 g of deionized water, 0.48 g of CAB-O-SIL® M-5 fumed silica, 0.15 g zeolite Y (Si:Al atomic ratio=2.56), and 0.01 g NES zeolite seeds (prepared according to Glaser et al., Catalysis Letters, 1998, pp. 141-148, 50) were mixed together in a 23 mL Parr reactor in a Teflon liner. The reactor was heated at 160° C. for 14 days under tumbling conditions (approximately 30 rpm). The product was isolated by filtration and rinsed with deionized water. Powder XRD (not shown) indicated that the product was a mixture of NES, MTW, and ANA zeolite phases.

### Mixture of NES/MOR Zeolite Under Scale-up Conditions Using Structure 12

3.47 g of the bis-pyridinium compound (Structure 12), 1.80 g of 1 N NaOH, 1.17 g of deionized water, 0.50 g of CBV-720 Y zeolite (Si:Al atomic ratio=15), and 0.01 g of NES zeolite seeds (prepared according to Glaser et al., Catalysis Letters, 1998, pp. 141-148, 50) were mixed together in a 23 mL Parr reactor in a Teflon liner. The reactor was heated at 160° C. for 20 days under tumbling conditions (approximately 30 rpm). Powder XRD (not shown) indicated that the product was NES with a minor MOR zeolite phase.

### Example 2: 1,1′-(pentane-1,5-diyl)bis(4-(tert-butyl)pyridin-1-ium) dihydroxide (Structure 13)

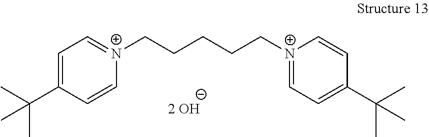 [SMILES: CC(C)(C)c1cc[n+](CCCCC[n+]2ccc(C(C)(C)C)cc2)cc1]

The bis-pyridinium compound (Structure 13) was prepared following the general procedure described above using 4-t-butylpyridine and 1,5-dibromopentane. A 10.2 wt % aqueous solution was utilized for the zeolite syntheses below.

### High-Throughput Beta Zeolite Synthesis Screening Reactions Using Structure 13

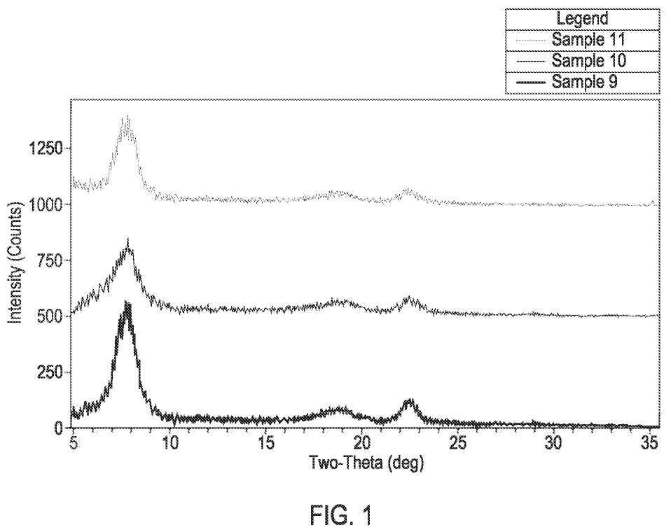

Pre-synthesis ratios of the reactants, reaction temperatures, and reaction times for various samples are specified in Table 3 below. The characterization results in Table 3 are based upon analysis of the powder XRD pattern of the products (FIG. 1) in comparison to known samples.

TABLE 3

| Sample | SDA:Si | H₂O:T⁺⁴ | Si:T^{+3,4} | MOH:Si | |
|---|---|---|---|---|---|
| No. | (atomic) | (atomic) | (atomic) | (atomic) | Silica Source |
| 9 | 0.15 | 41 | T = Al, 20 | M = Na, 0.30 | L |
| 10 | 0.15 | 39 | T = Al, 40 | M = Na, 0.15 | L |
| 11 | 0.15 | 39 | T = Al, 20 | M = Na, 0.15 | L |
| 12 | 0.15 | 42 | T = Al, 40 | M = Na, 0.30 | L |
| Sample | T⁺³ | HCl:Si | Temperature | Reaction Time | |
| No. | Source | (atomic) | (° C.) | (days) | Result |
| 9 | Y | 0 | 160 | 7 | Beta, broad |
| 10 | S | 0 | 120 | 28 | Beta, broad |
| 11 | MS-25 | 0 | 120 | 28 | Beta, broad |
| 12 | S | 0 | 120 | 28 | Beta, broad |

FIG. 1 shows a plot of comparative powder XRD patterns for various Beta zeolites made using a bis-pyridinium compound having Structure 13 as an SDA (Samples 9-11), pre-calcination (as-made). The powder XRD patterns substantially matched those of an authentic Beta (broad) zeolite sample.

### Beta Zeolite Synthesis Scale-up Using Structure 13

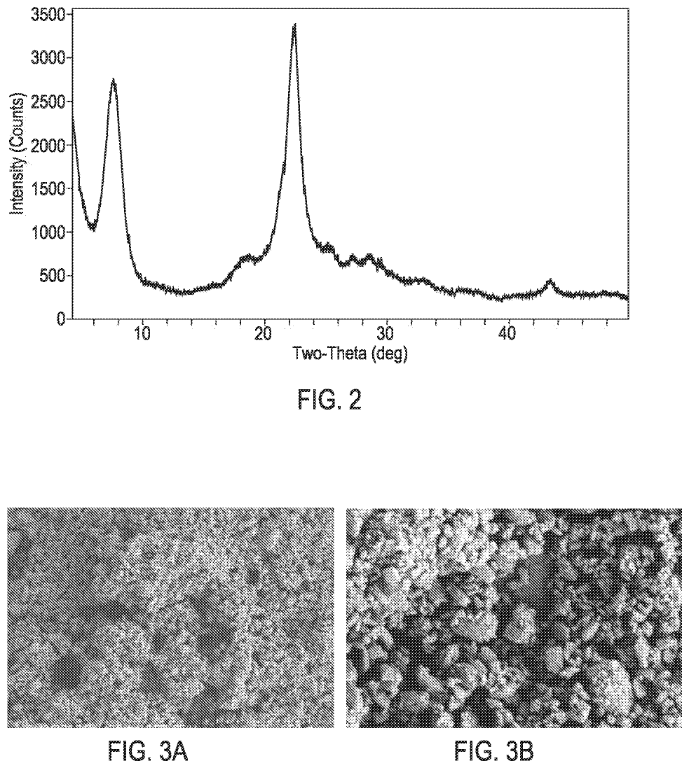

In a 23 mL Parr reactor containing a Teflon liner were added 9.54 g of a 10.16 wt % aqueous solution of the bis-pyridinium compound (Structure 13), 2.89 g of LUDOX® LS-30, 2.07 g of a 10 wt % aqueous solution of NaOH, 0.23 g deionized water, and 0.270 g of USY silica-alumina mixture (Si:Al atomic ratio=3). This ratio of reactants was approximately the same as Sample 9 above. The liner was then capped, and the reactor was heated at 160° C. for 13 days under tumbling conditions (about 30 rpm). The product (Sample 13) was isolated by filtration and rinsed with deionized water. FIG. 2 shows a plot of the powder XRD pattern for Beta zeolite produced under scale-up conditions using the bis-pyridinium compound having Structure 13 as an SDA (Sample 13), pre-calcination. The XRD pattern was substantially similar to that of an authentic Beta (broad) zeolite sample.

FIGS. 3A and 3B show illustrative SEM images at various magnifications of Beta zeolite produced under scale-up conditions using the bis-pyridinium compound having Structure 13 as an SDA (sample 13), pre-calcination.

### Example 3: 1,1′-(hexane-1,6-diyl)bis(4-(tert-butyl)pyridin-1-ium) dihydroxide (Structure 14)

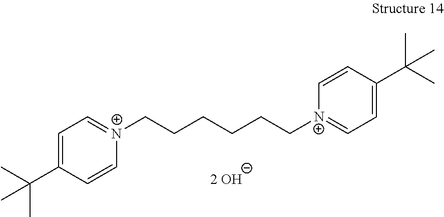 [SMILES: CC(C)(C)c1cc[n+](CCCCCC[n+]2ccc(C(C)(C)C)cc2)cc1]

The bis-pyridinium compound (Structure 14) was prepared following the general procedure, using 4-t-butylpyridine and 1,6-dibromohexane. A 23.6 wt % aqueous solution was utilized for the zeolite syntheses below.

### High-Throughput Beta Zeolite Synthesis Screening Reactions Using Structure 14

For high-throughput zeolite synthesis screening reactions, a 30 wt % aqueous silica suspension (LUDOX® LS-30 or AERODISP® W7330 N) was combined with an aqueous base solution (15 wt % to 30 wt % NaOH) and the aqueous solution of the SDA (Structure 14) under the reaction conditions specified in Table 4 below. The characterization results in Table 4 are based upon analysis of the powder XRD pattern of the products (not shown) in comparison to a known zeolite sample. Beta zeolite was obtained in each case. The product was not calcined in this instance.

TABLE 4

| Sample | SDA:Si | H₂O:T⁺⁴ | Si:T^{+3,4} | MOH:Si | |
|---|---|---|---|---|---|
| No. | (atomic) | (atomic) | (atomic) | (atomic) | Silica Source |
| 14^{a} | 0.15 | 30 | T = Al, 20 | 0 | L |
| 15 | 0.15 | 40 | T = B, 5 | M = Na, 0.10 | L |
| 16 | 0.15 | 30 | T = B, 10 | M = Na, 0.10 | L |
| 17 | 0.15 | 40 | T = B, 5 | M = Na, 0.10 | L |
| 18 | 0.15 | 30 | T = A1, 40 | M = Na, 0.15 | A |
| Sample | T⁺³ | HCl:Si | Temperature | Reaction Time | |
| No. | source | (atomic) | (° C.) | (days) | Result |
| 14 | MS-25 | ITQ-24 seeds | 160 | 28 | Beta, broad |
| 15 | B | 0 | 160 | 28 | Beta |
| 16 | B | 0 | 160 | 14 | Beta |
| 17 | B | 0 | 160 | 14 | Beta |
| 18 | S | 0 | 160 | 7 | Beta, broad |

^{a}prepared using 0.0045 g of ITQ-24 zeolite seeds per 0.0904 g of silica reactant

High-throughput zeolite synthesis screening reactions using the aqueous solution of the SDA (Structure 14) and tetramethylorthosilicate (TMOS) were also conducted under the conditions specified in Table 5 below. The characterization results in Table 5 are based upon analysis of the powder XRD pattern of the products (not shown) in comparison to a known sample. Beta zeolite was obtained in each case.

TABLE 5

| | | | | | | | Reaction | |
|---|---|---|---|---|---|---|---|---|
| Sample | SDA:Si | H₂O:Si | Si:T⁺³ | Silica | F:Si | Temperature | Time | |
| No. | (atomic) | (atomic) | (atomic) | Source | (atomic) | (° C.) | (days) | Result |
| 19 | 0.25 | 4 | T = B, 10 | TMOS | 0.5 | 150 | 10 | Beta |
| 20 | 0.25 | 4 | T = B, 5 | TMOS | 0 | 150 | 10 | Beta, |
| | | | | | | | | broad |
| 21 | 0.25 | 4 | T = B, 10 | TMOS | 0 | 150 | 10 | Beta, |
| | | | | | | | | broad |
| 22 | 0.25 | 10 | T = B, 5 | TMOS | 0 | 150 | 10 | Beta, |
| | | | | | | | | broad |
| 23 | 0.25 | 10 | T = B, 10 | TMOS | 0 | 150 | 10 | Beta, |
| | | | | | | | | broad |

### Example 4: 1,1′-(butane-1,4-diyl)bis(3-butylpyridin-1-ium) dihydroxide (Structure 27)

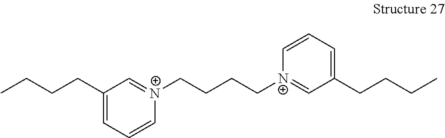 [SMILES: CCCCc1ccc[n+](CCCC[n+]2cccc(CCCC)c2)c1]

The bis-pyridinium compound (Structure 27) was prepared following the general procedure described above using 3-butylpyridine and 1,4-dibromobutane. A 10.4 wt % aqueous solution was utilized for the zeolite syntheses below.

### UZM-15/FU-1 Zeolite Synthesis Using Structure 27

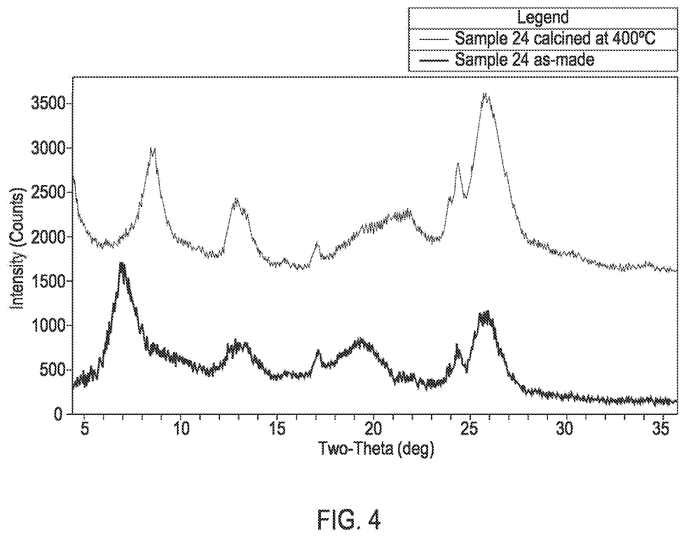

A hydrothermal synthesis was conducted using the bis-pyridinium compound having Structure 27 in combination with other reagents specified in Table 6 below. The reaction was heated at 120° C. for 28 days to provide Sample 24. The product was isolated and further calcined at 400° C. FIG. 4 shows a plot of comparative powder XRD patterns of Sample 24 pre-calcination (as-made) and post-calcination, made using the bis-pyridinium compound having Structure 27 as an SDA. The powder XRD patterns of Sample 24 were similar to those of FU-1 and EZM-15, as described respectively in U.S. Pat. Nos. 4,689,207 and 6,890,511.

TABLE 6

| Sample | SDA:Si | H₂O:T⁺⁴ | Si:T^{+3,4} | MOH:Si | Silica |
|---|---|---|---|---|---|
| No. | (atomic) | (atomic) | (atomic) | (atomic) | Source |
| 24 | 0.15 | 43 | T = Al, 10 | M = Na, 0.3 | L |
| | | | | Reaction | |
| Sample | T⁺³ | HCl:Si | Temperature | Time | |
| No. | Source | (atomic) | (° C.) | (days) | Result |
| 24 | S | 0 | 120 | 28 | UZM-15 |
| | | | | | and FU-1 |

### Example 5: 1,1′-(butane-1,4-diyl)bis(3,4-dimethylpyridin-1-ium) dihydroxide (Structure 15)

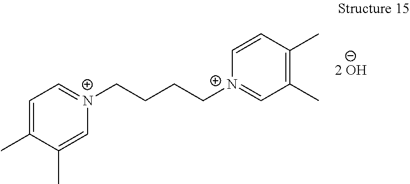

The bis-pyridinium compound (Structure 15) was prepared following the general procedure using 3,4-lutidine and 1,4-dibromobutane. An 11.4 wt % aqueous solution was utilized for the zeolite syntheses below.

### High-Throughput EMM-69 Germanosilicate Zeolite Synthesis Screening Reactions Using Structure 15

74.65 mg TMOS was added to 46.6 mg of the aqueous SDA solution (Structure 15). 12.83 mg GeO₂ was then added and mixed to create a uniform suspension. Water was then removed under freeze drying conditions, and sufficient water was then added to the freeze-dried solid to bring the total H₂O:Si ratio to 4. The reaction mixture was then heated in a sealed steel vessel at 150° C. for 10 days under tumbling conditions. Pre-synthesis ratios of the reactants, reaction temperatures, and reaction times for various samples are specified in Table 7 below. The characterization results in Table 7 are based upon analysis of the powder XRD pattern of the products in comparison to a known sample of EMM-69.

TABLE 7

| Sample | SDA:Si | H₂O:Si | Si:T^{+3,4} | |
|---|---|---|---|---|
| No. | (atomic) | (atomic) | (atomic) | Silica Source |
| 25 | 0.25 | 4 | T = Ge, 7.3 | TMOS |
| 26 | 0.25 | 4 | T = Ge, 4 | TMOS |
| | | | Reaction | |
| Sample | F:Si | Temperature | Time | |
| No. | (atomic) | (° C.) | (days) | Result |
| 25 | 0 | 150 | 28 | 75% EMM-69, 25% MFI |
| 26 | 0 | 150 | 10 | EMM-69 |

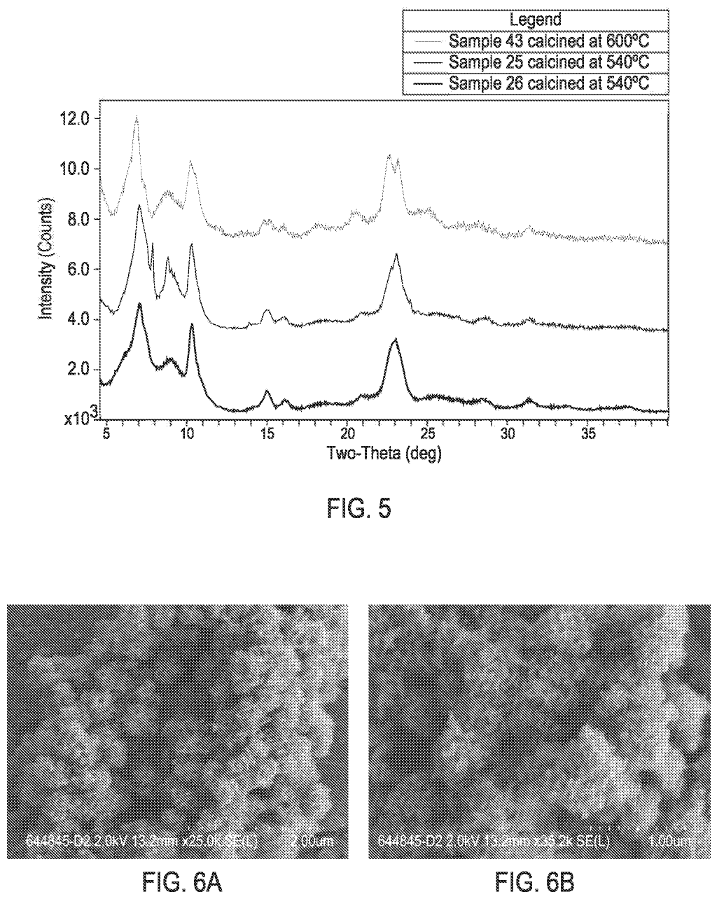

FIG. 5 shows a plot of comparative powder XRD patterns for various zeolites made with bis-pyridinium compounds having Structures 15 and 17 post-calcination (Samples 25, 26 and 43). Samples 25 and 26 were calcined at 540° C. The powder XRD patterns indicated that Sample 25 was 75% EMM-69 and 25% MFI, whereas Sample 26 was EMM-69. The synthesis of Sample 43, made using the SDA represented by Structure 17, is addressed further below.

### STW Germanosilicate Zeolite Synthesis Screening Reactions

The aqueous solution of the SDA (Structure 15) was utilized for a zeolite synthesis as specified in Table 8 below. The characterization results in Table 8 are based upon analysis of the powder XRD pattern (not shown) of the products in comparison to a known sample of STW. A trace amount of EMM-69 was also present.

TABLE 8

| Sample | SDA:Si | H₂O:Si | Si:T^{+3,4} | Silica | F:Si |
|---|---|---|---|---|---|
| No. | (atomic) | (atomic) | (atomic) | Source | (atomic) |
| 27 | 0.25 | 10 | T = Ge, 4 | TMOS | 0.5 |

| | | Reaction | |
|---|---|---|---|
| Sample | Temperature | Time | |
| No. | (° C.) | (days) | Result |
| 27 | 175 | 7 | STW with traces of EMM-69 |

### High-Throughput MTW Zeolite Synthesis

The aqueous solution of the SDA (Structure 15) was utilized for a series of high-throughput zeolite synthesis screening reactions. Pre-synthesis ratios of the reactants, reaction temperatures, and reaction times for various samples are specified in Table 9 below. The characterization results in Table 9 are based upon analysis of the powder XRD pattern (not shown) of the products in comparison to a known sample of MTW.

TABLE 9

| Sample | SDA:Si | H₂O:T⁺⁴ | Si:T^{+3,4} | MOH:Si | Silica |
|---|---|---|---|---|---|
| No. | (atomic) | (atomic) | (atomic) | (atomic) | Source |
| 28 | 0.15 | 30 | T = Al, 40 | 0 | L |
| 29 | 0.15 | 40 | T = B, 10 | M = Na, 0.10 | L |
| 30 | 0.15 | 30 | T= B, 20 | M = Li, 0.10 | L |
| 31 | 0.15 | 49 | T = B, 5 | M = Na, 0.10 | L |
| 32 | 0.15 | 37 | T = Al, 40 | M = Na, 0.30 | L |
| 33^{a} | 0.15 | 30 | Al, 20 | 0 | L |
| 34 | 0.15 | 41 | B, 20 | M = Na, 0.30 | L |
| 35 | 0.15 | 38 | Al, 20 | M = Na, 0.30 | L |
| Sample | T⁺³ | HCl:Si | Temperature | Reaction Time | |
| No. | Source | (atomic) | (° C.) | (days) | Result |
| 28 | MS-25 | 0 | 160 | 14 | MTW |
| 29 | B | 0 | 160 | 14 | MTW |
| 30 | B | 0 | 160 | 14 | MTW |
| 31 | B | 0 | 160 | 14 | MTW |
| 32 | S | 0.30 | 120 | 28 | MTW |
| 33^{a} | MS-25 | 0 | 160 | 28 | MTW |
| 34 | B | 0.30 | 120 | 28 | MTW |
| 35 | S | 0.30 | 160 | 28 | MTW |

^{a}0.0023 g ITQ-33 zeolite seed used per 46.1 g silica

### Example 6: 1,1′-(pentane-1,5-diyl)bis(3,4-dimethylpyridin-1-ium) dihydroxide (Structure 16)

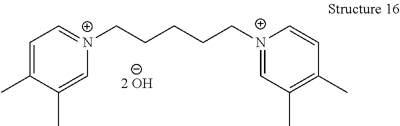

The bis-pyridinium compound (Structure 16) was formed by mixing 3,4-lutidine and 1,5-dibromopentane following the general procedure described above. An 8.4 wt % aqueous solution was utilized for the zeolite syntheses below.

### NES Zeolite Synthesis Screening Reactions Using Structure 16

The aqueous solution of the SDA (Structure 16) was utilized for a zeolite synthesis as specified in Table 10 below. The characterization results in Table 10 are based upon analysis of the powder XRD pattern (not shown) of the products in comparison to a known sample of NES.

TABLE 10

| Sample | SDA:Si | H₂O:T⁺⁴ | Si:T^{+3,4} | MOH:Si | Silica |
|---|---|---|---|---|---|
| No. | (atomic) | (atomic) | (atomic) | (atomic) | Source |
| 36 | 0.15 | 42 | T = Al, 20 | 0 | L |
| Sample | T⁺³ | HCl:Si | Temperature | Reaction Time | |
| No. | source | (atomic) | (° C.) | (days) | Result |
| 36 | Y | 0 | 160 | 28 | NES |

### High-Throughput IZM-2 Zeolite Synthesis Screening Reactions Using Structure 16

The aqueous solution of the SDA (Structure 16) was utilized for a series of high-throughput zeolite synthesis screening reactions. Pre-synthesis ratios of the reactants, reaction temperatures, and reaction times for various samples are specified in Table 11 below. The characterization results in Table 11 are based upon analysis of the powder XRD pattern (not shown) of the products in comparison to a known sample of IZM-2.

TABLE 11

| Sample | SDA:Si | H₂O:T⁺⁴ | Si:T^{+3,4} | MOH:Si | Silica |
|---|---|---|---|---|---|
| No. | (atomic) | (atomic) | (atomic) | (atomic) | Source |
| 37 | 0.15 | 44 | T = Al, 20 | M = K, 0.30 | L |
| 38 | 0.15 | 46 | T = Al, 40 | M = Na, 0.30 | L |
| 39 | 0.15 | 48 | T = Al, 10 | M = Na, 0.30 | L |
| 40 | 0.15 | 42 | T = Al, 40 | M = Na, 0.15 | L |
| 41 | 0.15 | 50 | T = B, 20 | M = Na, 0.30 | L |
| Sample | T⁺³ | HCl:Si | Temperature | Reaction Time | |
| No. | source | (atomic) | (° C.) | (days) | Result |
| 37 | K | 0.30 | 120 | 28 | IZM-2 |
| 38 | S | 0.30 | 120 | 28 | IZM-2 |
| 39 | S | 0.30 | 120 | 28 | IZM-2 |
| 40 | S | 0.15 | 120 | 28 | IZM-2 |
| 41 | B | 0.30 | 120 | 28 | IZM-2 |

### Example 7: 1,1′-(hexane-1,6-diyl)bis(3,4-dimethylpyridin-1-ium) dihydroxide (Structure 17)

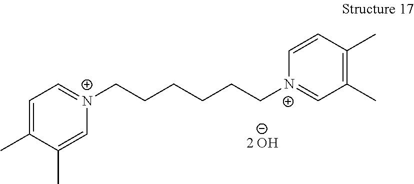

The bis-pyridinium compound (Structure 17) was formed by mixing 3,4-lutidine and 1,6-dibromohexane following the general procedure described above. A 9.1 wt % aqueous solution was utilized for the zeolite syntheses below.

### High-Throughput EMM-69 Germanosilicate Zeolite Synthesis Screening Reactions Using Structure 17

The aqueous solution of the SDA (Structure 17) was utilized for a series of high-throughput zeolite synthesis screening reactions. Pre-synthesis ratios of the reactants, reaction temperatures, and reaction times for various samples are specified in Table 12 below. The characterization results in Table 12 are based upon analysis of the powder XRD pattern of the products in comparison to a known sample of EMM-69. The powder XRD patterns of Sample 43 after calcination at 600° C. is shown in FIG. 5 above.

TABLE 12

| Sample | SDA:Si | H₂O:Si | Si:T^{+3,4} | Silica |
|---|---|---|---|---|
| No. | (atomic) | (atomic) | (atomic) | Source |
| 42 | 0.25 | 10 | T = Ge, 7.3 | TMOS |
| 43 | 0.25 | 10 | T = Ge, 4 | TMOS |
| Sample | F:Si | Temperature | Reaction Time | |
| No. | (atomic) | (° C.) | (days) | Result |
| 42 | 0 | 175 | 7 | 90% EMM-69, 10% MFI |
| 43 | 0 | 175 | 7 | EMM-69 |

FIGS. 6A and 6B show illustrative SEM images of Sample 43 pre-calcination at various magnifications, made using the bis-pyridinium compound having Structure 17 as an SDA.

### Scale-up Synthesis of Sample 43 Using Structure 17

A larger scale synthesis of Sample 43 (Si:Ge atomic ratio=4) was conducted using a 23 mL Parr reactor equipped with a Teflon-coated liner. After 7 days of heating, the EMM-69 zeolite product was isolated by filtration and rinsed with deionized water. A portion of the EMM-69 zeolite product was calcined at 500° C., and submitted for adsorption experiments. For the adsorption experiments, the sample was placed under a nitrogen stream and the hydrocarbon was introduced through a sparger to saturate the nitrogen stream with hydrocarbon. The hydrocarbon uptake was then determined. In the adsorption measurements, n-hexane was adsorbed at 90° C., 2,2-dimethylbutane was adsorbed at 120° C., and mesitylene was adsorbed at 100° C. The calcined EMM-69 zeolite had a BET surface area of 484 m²/g, an external surface area of 193 m²/g, and a micropore volume of 0.125 cc/g; an n-hexane adsorption of 71 mg/g, a 2,2-dimethylbutane adsorption of 50 mg/g, and a mesitylene adsorption of 40 mg/g.

### Scale-up of Sample 42 Using Structure 17

A larger scale synthesis of Sample 42 (Si:Ge atomic ratio=7.3) was conducted using a 23 mL Parr reactor equipped with a Teflon-coated liner. After 7 days of heating, the EMM-69/MFI zeolite product was isolated by filtration, and rinsed with deionized water (90% EMM-69, 10% MFI).

Modified Scale-up Procedure Using Seeds from Sample 43 (EMM-69) to produce pure EMM-69 Zeolite (Sample 44) Using Structure 17

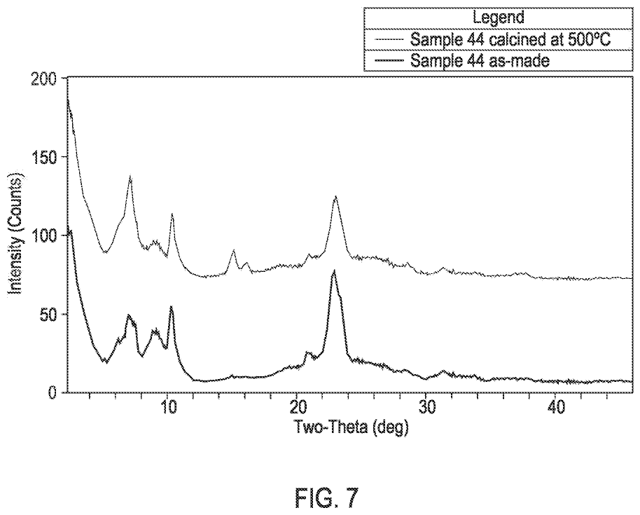

The scale-up synthesis of Sample 42 (Si:Ge atomic ratio=7.3) was repeated using a 23 mL Parr reactor equipped with a Teflon-coated liner and with a small quantity of EMM-69 seeds (Sample 43) also added to the reaction mixture. After heating at 175° C. for 6 days, EMM-69 (Sample 44) was obtained and was calcined at 500° C. A portion of the calcined zeolite product was submitted for adsorption experiments, as described previously. The calcined zeolite product had a BET surface area of 562 m²/g, an external surface area of 221 m²/g, a micropore volume of 0.146 cc/g, a n-hexane adsorption of 75 mg/g, a 2,2-dimethylbutane adsorption of 63 mg/g, and a mesitylene adsorption of 33 mg/g. FIG. 7 shows a plot of comparative powder XRD patterns of Sample 44 produced using EMM-69 seeds and the bis-pyridinium compound having Structure 17 as an SDA, pre-calcination (as-made) and post-calcination. The broad features of the powder XRD pattern are consistent those expected for a material having very small crystallites and a high external surface area.

The powder XRD pattern of the as-synthesized EMM-69 (Sample 44) included the peaks shown in Table 13.

TABLE 13

| 2θ scattering angles | | Relative Intensity |
|---|---|---|
| (+/−0.20 degrees) | d-spacing | [100 × I/I(o)] (%) |
| 6.25 | 14.12 | 2.9 |
| 7.04 | 12.54 | 38.3 |
| 7.49 | 11.79 | 19.8 |
| 9.03 | 9.79 | 25.1 |
| 10.29 | 8.59 | 57.7 |
| 15.10 | 5.86 | 5.9 |
| 19.38 | 4.58 | 3 |
| 20.80 | 4.27 | 13.9 |
| 22.86 | 3.89 | 100 |
| 23.33 | 3.81 | 66 |
| 25.47 | 3.49 | 4.5 |
| 28.50 | 3.13 | 5.5 |
| 31.30 | 2.86 | 13.2 |
| 37.39 | 2.40 | 5.4 |

The powder XRD pattern of the EMM-69 (Sample 44) obtained after calcination at 500° C. included the peaks shown in Table 14.

TABLE 14

| 2θ scattering angles | | Relative Intensity |
|---|---|---|
| (+/−0.20 degrees) | d-spacing | [100 × I/I(o)] (%) |
| 6.36 | 13.88 | 14.1 |
| 7.13 | 12.39 | 86.6 |
| 9.15 | 9.66 | 13.1 |
| 10.36 | 8.53 | 72.3 |
| 15.04 | 5.89 | 32.8 |
| 16.09 | 5.50 | 11.9 |
| 18.73 | 4.73 | 5.9 |
| 20.95 | 4.24 | 9.8 |
| 22.99 | 3.87 | 100 |
| 23.46 | 3.79 | 53.6 |
| 26.12 | 3.41 | 3.5 |
| 28.55 | 3.12 | 10 |
| 31.47 | 2.84 | 10.6 |
| 37.35 | 2.41 | 6.1 |

Scale-Up Synthesis of EMM-69 with a Modified Aluminosilicate Ratio Using Structure 17

Sample 44 was resynthesized under modified scale-up conditions with a Si:Al atomic ratio of 35 and heating under tumbling conditions for 6 days at 175° C. Al(OH)₃ was used to adjust the amount of Al present. Powder XRD (not shown) indicated that the zeolite product (Sample 45) was EMM-69. Sample 45 was calcined at 500° C. After calcination, Sample 45 exhibited an alpha value of 82.

### High-Throughput NES Zeolite Synthesis Screening Reactions Using Structure 17

The aqueous solution of the SDA (Structure 17) was utilized for a series of high-throughput zeolite synthesis screening reactions. Pre-synthesis ratios of the reactants, reaction temperatures, and reaction times for various samples are specified in Tables 15A and 15B below. The characterization results in Tables 15A and 15B are based upon analysis of the powder XRD pattern of the products (not shown) in comparison to a known sample of NES.

TABLE 15A

| Sample | SDA:Si | H₂O:T⁺⁴ | Si: T^{+3,4} | MOH:Si | Silica |
|---|---|---|---|---|---|
| No. | (atomic) | (atomic) | (atomic) | (atomic) | Source |
| 46ª | 0.15 | 35 | T = Al, 20 | 0 | L |
| 47 | 0.15 | 43 | T = Al, 5 | M = Na/K, 0.15 | L |
| 48 | 0.15 | 48 | T = Al, 10 | M = Na/K, 0.15 | L |
| 49 | 0.15 | 44 | T = Al, 10 | M = Li, 0.3 | L |
| | | | | Reaction | |
| Sample | T⁺³ | HCl:Si | Temperature | Time | |
| No. | source | (atomic) | (° C.) | (days) | Result |
| 46 | MS-25 | 0 | 160 | 28 | NES |
| 47 | MS-25 | 0 | 160 | 28 | NES |
| 48 | S | 0.30 | 160 | 14 | NES, broad |
| 49 | MS-25 | 0.30 | 160 | 14 | NES, layered |

^{a}used 2 mg ITQ-33 zeolite seeds per 40.3 mg of silica from silica source

TABLE 15B

| Sample | SDA:Si | H₂O:Si | Si: T^{+3,4} | Silica | |
|---|---|---|---|---|---|
| No. | (atomic) | (atomic) | (atomic) | Source | |
| 50^{a} | 0.25 | 4 | All-silica | TMOS | |
| 51 | 0.25 | 10 | T = B, 40 | TMOS | |
| 52 | 0.25 | 10 | T = A1, 50 | TMOS | |
| 53 | 0.25 | 4 | T = A1, 50 | TMOS | |
| | | | | Reaction | |
| Sample | T³⁺ | F:Si | Temperature | Time | |
| No. | Source | (atomic) | (° C.) | (days) | Result |
| 50 | — | 0.5 | 175 | 7 | NES |
| 51 | B | 0.5 | 175 | 7 | NES |
| 52 | iso | 0.5 | 175 | 7 | NES |
| 53 | iso | 0.5 | 175 | 7 | NES |

^{a}used 1.4 mg ITQ-24 zeolite seeds per 71.2 mg of silica from silica source

### EMM-17 Zeolite Synthesis Screening Reactions Using Structure 17

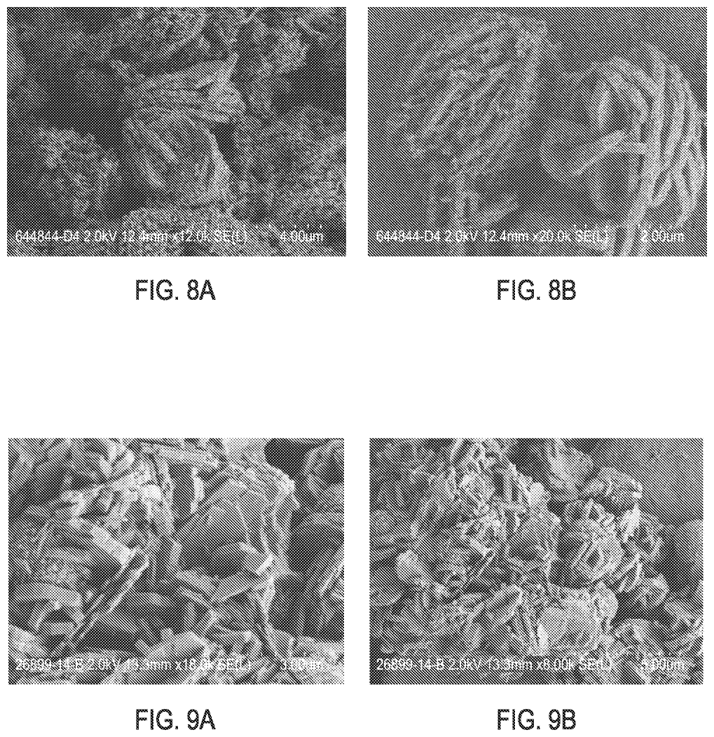

The aqueous SDA solution (Structure 17) was utilized under the conditions specified in Table 16 below. The characterization results in Table 16 are based upon analysis of the powder XRD pattern of the products (not shown) in comparison to a known sample of EMM-17. When the zeolite synthesis was conducted in the presence of ITQ-33 seeds, a mixture of about 75% EMM-17 and about 25% amorphous material was obtained (Sample 54). In comparison, under different thermal conditions and in the presence of ITQ-24 seeds, NES zeolite was produced instead (Sample 50). FIGS. 8A and 8B show illustrative SEM images of Sample 54 pre-calcination at various magnifications, made using the bis-pyridinium compound having Structure 17 as an SDA.

TABLE 16

| Sample | SDA:Si | H₂O:Si | Si: T^{+3,4} | Silica | F:Si |
|---|---|---|---|---|---|
| No. | (atomic) | (atomic) | (atomic) | Source | (atomic) |
| 54ª | 0.25 | 4 | All-silica | TMOS | 0.5 |

| | | Reaction | |
|---|---|---|---|
| Sample | Temperature | Time | |
| No. | (° C.) | (days) | Result |
| 54ª | 150 | 10 | About 75% EMM-17 and 25% |
| | | | amorphous material |

^{a}used 1.4 mg ITQ-33 zeolite seeds per 71.2 g of silica from silica source

### Scale-up of Sample 55 to Produce EMM-17/MTW Zeolite (Sample 55) Using Structure 17

A scale-up synthesis of Sample 54 was attempted using a 23 mL Parr reactor equipped with a Teflon-coated liner and 1.7 g of TMOS as a silica source. After heating at 160° C. for 13 days under tumbling conditions (about 30 rpm), the zeolite product (Sample 55) was isolated by filtration and rinsed with deionized water. Instead of an EMM-17/amorphous mixture (Sample 54), the powder XRD pattern (not shown) indicated that a mixture of 90% EMM-17 and 10% MTW was obtained (Sample 55). FIGS. 9A and 9B show illustrative SEM images of the zeolite mixture of Sample 55 pre-calcination at various magnifications, made using the bis-pyridinium compound having Structure 17 as an SDA.

### High-Throughput ZSM-12 Zeolite Synthesis Screening Reactions Using Structure 17

The aqueous solution of the SDA (Structure 17) was utilized for a series of high-throughput zeolite synthesis screening reactions. Pre-synthesis ratios of the reactants, reaction temperatures, and reaction times for various samples are specified in Table 17 below. The characterization results in Table 17 are based upon analysis of the powder XRD pattern of the products (not shown) in comparison to a known sample of ZSM-12.

TABLE 17

| Sample | SDA:Si | H₂O: T⁺⁴ | Si: T^{+3,4} | MOH:Si | Silica |
|---|---|---|---|---|---|
| No. | (atomic) | (atomic) | (atomic) | (atomic) | Source |
| 56 | 0.15 | 57 | T = B, 5 | M = Na, 0.10 | L |
| 57 | 0.15 | 51 | T = B, 20 | M = Li, 0.30 | L |
| 58 | 0.15 | 47 | T = B, 10 | M = Na, 0.10 | L |

| Sample | HCl:Si | Temperature | Reaction Time | |
|---|---|---|---|---|
| No. | (atomic) | (° C.) | (days) | Result |
| 56 | 0 | 160 | 7 | ZSM-12 |
| 57 | 0.3 | 160 | 7 | ZSM-12 |
| 58 | 0 | 160 | 7 | ZSM-12 |

### Example 8: 1,1′-(butane-1,4-diyl)bis(3,5-dimethylpyridin-1-ium) dihydroxide (Structure 18)

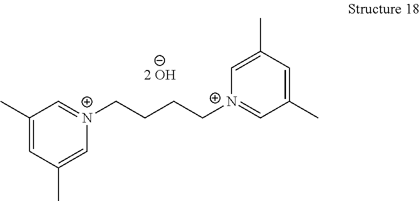

The bis-pyridinium compound (Structure 18) was formed by mixing 3,5-lutidine and 1,4-dibromobutane following the general procedure described above. A 11.6 wt % aqueous solution was utilized for the zeolite syntheses below.

### High-Throughput PST-22 Zeolite Synthesis Screening Reactions Using Structure 18

The aqueous SDA solution (Structure 18) was utilized for a zeolite synthesis using the pre-synthesis ratios of reactants, reaction temperatures, and reaction specified in Table 18 below. The characterization results in Table 18 are based upon analysis of the powder XRD pattern of the products (not shown) in comparison to a known sample of PST-22. The powder XRD patterns indicated that Sample 59 was PST-22 with layered impurity (not shown).

TABLE 18

| Sample | SDA:Si | H₂O:Si | Si: T^{+3,4} | Silica |
|---|---|---|---|---|
| No. | (atomic) | (atomic) | (atomic) | Source |
| 59 | 0.25 | 4 | T = Al, 20 | TMOS |
| Sample | F:Si | Temperature | Reaction Time | |
| No. | (atomic) | (° C.) | (days) | Result |
| 59 | 0.5 | 175 | 7 | PST-22 with layered |
| | | | | impurity |

### Scale-up Zeolite Synthesis Screening Reactions Under Fluoride Conditions Using Structure 18

In this example, tetraethylorthosilicate (TEOS) was used instead of TMOS, and aluminum hydroxide (Sigma-Aldrich) was used as the aluminum source. The reactants were mixed together within a 23 mL Parr reactor equipped with a Teflon liner under the conditions specified in Table 19 below. After evaporating ethanol and excess water over the course of 2-3 days, deionized water was back-added to obtain a target H₂O:Si atomic ratio of 5. The reactor was heated at 175° C. under tumbling conditions (about 30 rpm). The characterization results in Table 19 are based upon analysis of the powder XRD pattern of the products (not shown) in comparison to a known sample of MWT or PST-22.

TABLE 19

| Sample | SDA:Si | H₂O:Si | Si: T^{+3,4} | Silica | F:Si |
|---|---|---|---|---|---|
| No. | (atomic) | (atomic) | (atomic) | Source | (atomic) |
| 60 | 0.25 | 5 | All-silica | TEOS | 1.0 |
| 61 | 0.25 | 5 | T = Al, 10 | TEOS | 1.5 |
| 62 | 0.25 | 5 | T = Al, 25 | TEOS | 1.5 |
| 63 | 0.25 | 5 | T = Al, 25 | TEOS | 1.0 |
| 64 | 0.25 | 5 | T = Al, 25 | TEOS | 0.5 |

| Sample | Temperature | Reaction Time | |
|---|---|---|---|
| No. | (° C.) | (days) | Result |
| 60 | 175 | 7 | MTW |
| 61 | 175 | 7 | PST-22 |
| 62 | 175 | 7 | PST-22 |
| 63 | 175 | 7 | PST-22 |
| 64 | 175 | 7 | PST-22 |

### High-Throughput PST-22 Zeolite Synthesis Screening Reactions Using LUDOX® LS-30 and Structure 18

The aqueous SDA solution (Structure 18) was utilized for a series of high-throughput zeolite synthesis screening reactions. Pre-synthesis ratios of the reactants, reaction temperatures, and reaction times for various samples are specified in Table 20 below. The characterization results in Table 20 are based upon analysis of the powder XRD pattern of the products (not shown) in comparison to a known sample of PST-22.

TABLE 20

| Sample | SDA:Si | H₂O: T⁺⁴ | Si: T^{+3,4} | MOH:Si | Silica |
|---|---|---|---|---|---|
| No. | (atomic) | (atomic) | (atomic) | (atomic) | Source |
| 65 | 0.15 | 36 | T = Al, 10 | M = Na, 0.30 | L |
| 66 | 0.15 | 36 | T = Al, 20 | M = Na, 0.30 | L |
| 67 | 0.15 | 36 | T = Al, 10 | M = Li, 0.3 | L |
| 68 | 0.15 | 33 | T = Al, 20 | M = Na, 0.30 | L |
| 69 | 0.15 | 32 | T = Al, 10 | M = K, 0.30 | L |
| 70 | 0.15 | 33 | T = Al, 10 | M = Na, 0.30 | L |
| 71 | 0.15 | 32 | T = Al, 10 | M = Na, 0.30 | L |
| 72 | 0.15 | 37 | T = Al, 20 | M = Na, 0.30 | L |
| 73 | 0.15 | 37 | T = Al, 10 | M = Na/K, 0.15 | L |
| 74 | 0.15 | 34 | T = Al, 40 | M = Na, 0.30 | L |
| 75 | 0.15 | 36 | T = Al, 10 | M = Na, 0.30 | L |
| 76 | 0.15 | 40 | T = Al, 10 | M = Na/K, 0.15 | L |
| Sample | T⁺³ | HCl:Si | Temperature | Reaction Time | |
| No. | Source | (atomic) | (° C.) | (days) | Result |
| 65 | S | 0 | 120 | 28 | PST-22, |
| | | | | | ANA |
| 66 | MK | 0 | 160 | 28 | PST-22 |
| | | | | | with traces |
| | | | | | of quartz |
| 67 | MS-25 | 0.30 | 160 | 28 | PST-22 |
| 68 | MK | 0 | 120 | 28 | PST-22 |
| 69 | K | 0 | 120 | 28 | PST-22 |
| 70 | MK | 0 | 160 | 28 | PST-22 |
| 71 | Y | 0 | 160 | 28 | PST-22 |
| 72 | S | 0.30 | 160 | 28 | PST-22, |
| | | | | | quartz |
| 73 | S | 0 | 160 | 28 | PST-22 |
| 74 | S | 0 | 120 | 28 | PST-22 |
| 75 | S | 0 | 160 | 28 | PST-22 |
| 76 | S | 0.30 | 160 | 28 | PST-22 |

FIGS. 10A and 10B show illustrative SEM images of Sample 65 at various magnifications, made using the bis-pyridinium compound having Structure 18 as an SDA. The crystallites were generally less than 0.5 microns in size.

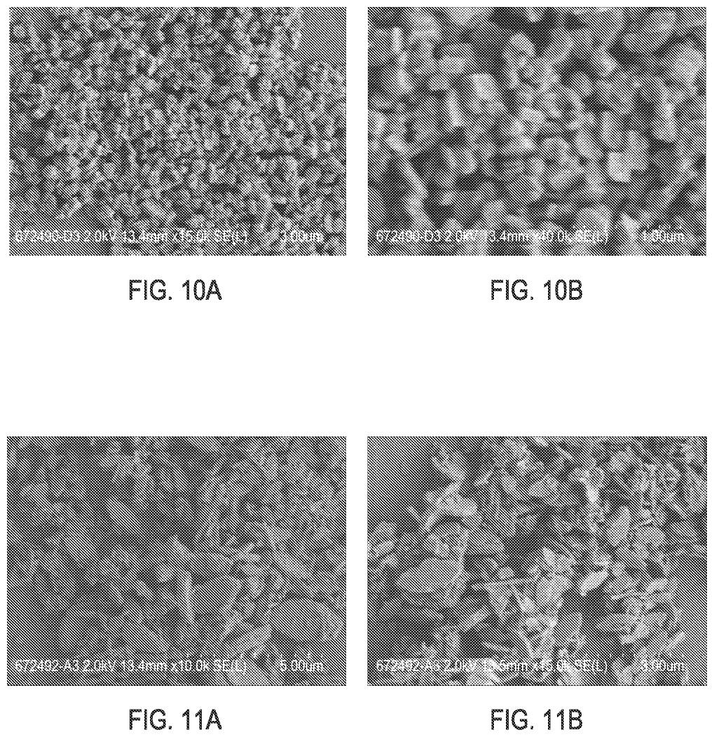

FIGS. 11A and 11B show illustrative SEM images of Sample 67 at various magnifications, made using the bis-pyridinium compound having Structure 18 as an SDA. The plates of Sample 67 were about 1 to 4 microns in size.

### Attempted Scale-up of Sample 66 Using PST-22 Seeds (Sample 77)

An attempted scale-up synthesis of Sample 66 was conducted using a 125 mL Parr reactor equipped with a Teflon-coated liner. To the liner were added 44.0 g of the aqueous solution of the SDA (Structure 18), 21.0 g of LUDOX® LS-30, 13.4 g of a 10 wt % aqueous solution of NaOH, 0.9 g deionized water, and 0.65 g of metakaolin, and 0.065 g of PST-22 seeds. The reactor was heated at 160° C. for 7 days under tumbling conditions (about 30 rpm). The product was isolated by filtration, and rinsed with deionized water, affording PST-22 zeolite with quartz impurities (Sample 77). The product was further calcined at 600° C. under the general conditions specified above.

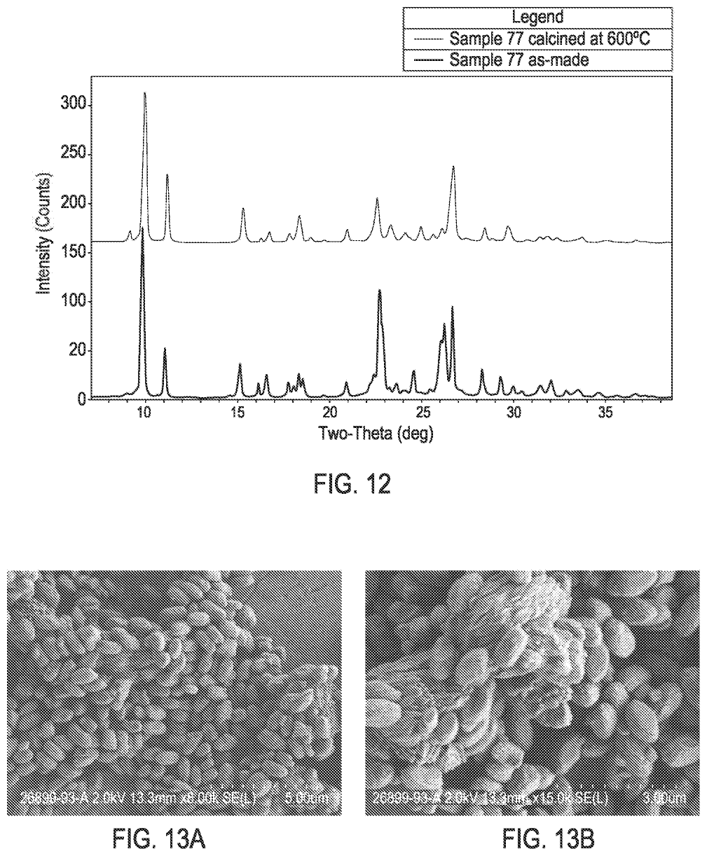

FIG. 12 shows a plot of comparative powder XRD patterns of Sample 77 pre-calcination (as-made) and post-calcination, made using the bis-pyridinium compound having Structure 18 as an SDA. Quartz impurity peaks are indicated by asterisks.

The XRD pattern of the as-synthesized PST-22 zeolite (Sample 77) included the peaks in Table 21.

TABLE 21

| 2θ scattering angles | d-spacing | Relative Intensity |
|---|---|---|
| (+/− 0.20 degrees) | (Å) | [100 × I/I(o)] (%) |
| 9.83 | 8.99 | 100 |
| 11.06 | 7.99 | 23 |
| 15.13 | 5.85 | 22 |
| 16.57 | 5.35 | 15 |
| 18.53 | 4.79 | 15 |
| 22.41 | 3.96 | 15 |
| 22.71 | 3.91 | 92 |
| 22.90 | 3.88 | 23 |
| 24.54 | 3.62 | 17 |
| 26.02 | 3.42 | 37 |
| 26.23 | 3.39 | 50 |
| 28.27 | 3.15 | 17 |
| 29.29 | 3.05 | 12 |
| 31.41 | 2.85 | 13 |
| 32.04 | 2.79 | 15 |

The X-ray diffraction pattern of the PST-22 zeolite (Sample 77) after calcination at 600° C. included the peaks in Table 22.

TABLE 22

| 2θ scattering angles | d-spacing | Relative Intensity |
|---|---|---|
| (+/− 0.20 degrees) | (Å) | [100 × I/I(o)] (%) |
| 9.95 | 8.88 | 100 |
| 11.18 | 7.91 | 37 |
| 15.31 | 5.78 | 28 |
| 18.34 | 4.83 | 26 |
| 22.59 | 3.93 | 50 |
| 23.31 | 3.81 | 18 |
| 24.10 | 3.69 | 9 |
| 24.97 | 3.56 | 12 |
| 26.57 | 3.35 | 46 |
| 28.45 | 3.14 | 9 |
| 29.66 | 3.01 | 16 |
| 34.88 | 2.57 | 11 |

FIGS. 13A and 13B show illustrative SEM images of Sample 77 at various magnifications, made using the bis-pyridinium compound having Structure 18 as an SDA.

### Modified Synthesis of Sample 66 Using Si:Al Atomic Ratio of 10, at a Temperature of 150° C. (Sample 78) Using Structure 18

A scale-up synthesis of Sample 66 was conducted using a 23 mL Parr reactor equipped with a Teflon-coated liner. To the liner were added 9.90 g of the aqueous SDA solution (Structure 18), 3.70 g of LUDOX® LS-30, 3.0 g of a 10 wt % aqueous solution of NaOH, 0.82 g deionized water, and 0.58 g of metakaolin, and 0.013 g of PST-22 seeds (Sample 71). The reactor was heated at 150° C. for 7 days under tumbling conditions (about 30 rpm). The zeolite product (Sample 78) was isolated by filtration, and rinsed with deionized water, affording PST-22 zeolite with a minor analcime impurity.

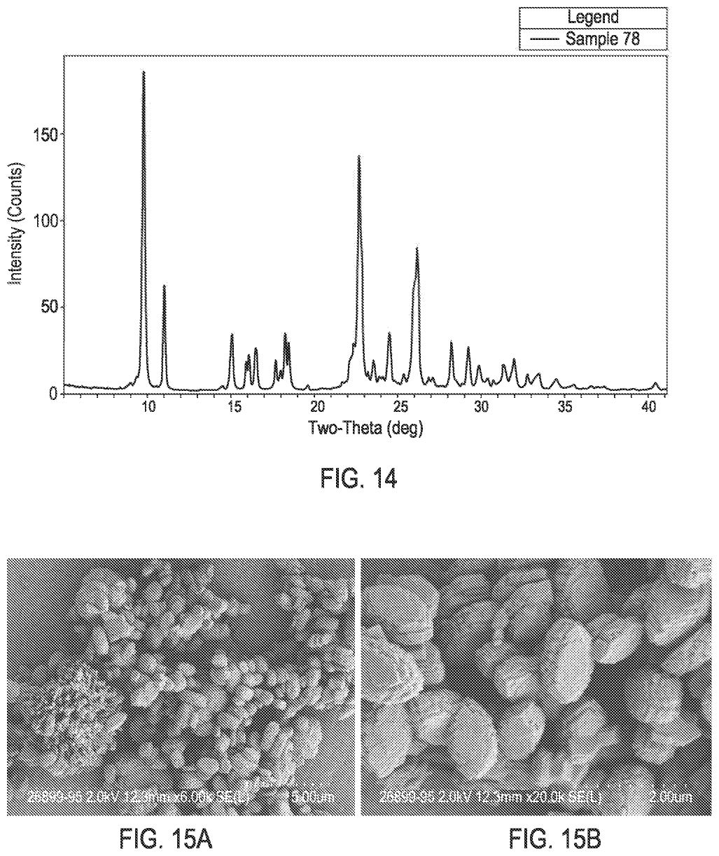

FIG. 14 shows a plot of the powder XRD pattern of Sample 78 pre-calcination (as-made), made using the bis-pyridinium compound having Structure 18. Peaks of analcime are indicated by asterisks at 16° 2 Theta.

FIGS. 15A and 15B show illustrative SEM images of Sample 78 at various magnifications, made using the bis-pyridinium compound of Structure 18.

### Modified Synthesis of Sample 78 Using a K:Si Atomic Ratio of 0.30 at a Temperature of 135° C. (Sample 79) Using Structure 18

The previous example was repeated with KOH at a K:Si atomic ratio of 0.30 and a reactor temperature of 135° C. for 18 days under tumbling conditions (about 30 rpm). The product (Sample 79) was isolated by filtration, and rinsed with deionized water. The powder XRD pattern (not shown) of Sample 79 confirmed that a pure PST-22 zeolite was obtained.

### High-Throughput Zeolite Synthesis Screening Reactions

The aqueous SDA solution (Structure 18) was utilized for a series of high-throughput zeolite synthesis screening reactions. Pre-synthesis ratios of the reactants, reaction temperatures, and reaction times for various samples are specified in Table 23 below. A previously unknown zeolite structure, now designated EMM-XY, was obtained in both cases.

TABLE 23

| Sample | SDA:Si | H₂O:Si | Si:T⁺³ | Silica |
|---|---|---|---|---|
| No. | (atomic) | (atomic) | (atomic) | Source |
| 80 | 0.25 | 4 | T = B, 40 | TMOS |
| 81 | 0.25 | 4 | All-silica | TMOS |
| Sample | F:Si; Cl:Si | Temperature | Reaction Time | |
| No. | (atomic) | (° C.) | (days) | Result |
| 80 | 0.25; 0.25 | 150 | 10 | EMM-XY |
| 81 | 0.25; 0.25 | 150 | 10 | EMM-XY |

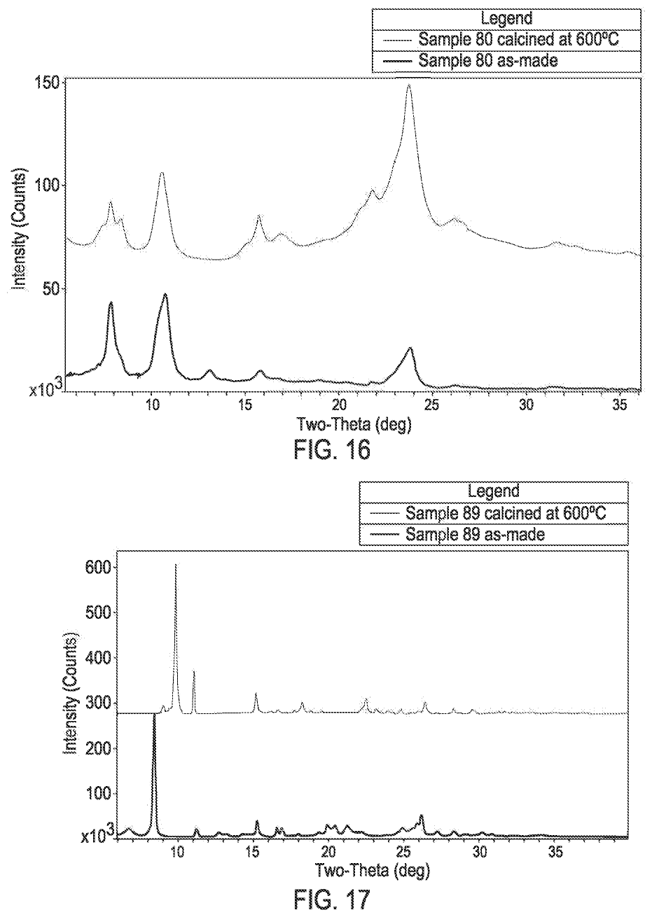

FIG. 16 shows comparative powder XRD patterns of Sample 80 pre-calcination (as-made) and post-calcination, made using the bis-pyridinium compound having Structure 18. The XRD pattern of the as-synthesized zeolite material (Sample 80) included the peaks in Table 24.

TABLE 24

| 2θ scattering angles | d-spacing | Relative Intensity |
|---|---|---|
| (+/− 0.20 degrees) | (Å) | [100 × I/I(o)] (%) |
| 7.86 | 11.24 | 85 |
| 10.74 | 8.23 | 100 |
| 13.05 | 6.78 | 12 |
| 15.80 | 5.60 | 14 |
| 16.70 | 5.31 | 5 |
| 19.01 | 4.67 | 2 |
| 20.48 | 4.33 | 3 |
| 21.83 | 4.07 | 5 |
| 23.13 | 3.84 | 21 |
| 23.86 | 3.73 | 45 |
| 26.44 | 3.37 | 4 |
| 27.25 | 3.27 | 2 |
| 31.58 | 2.83 | 3 |

The XRD pattern of the zeolite material (Sample 80) after calcination at 600° C. included the peaks in Table 25.

TABLE 25

| 2θ scattering angles | d-spacing | Relative Intensity |
|---|---|---|
| (+/− 0.20 degrees) | (Å) | [100 × I/I(o)] (%) |
| 6.25 | 14.12 | 3 |
| 7.04 | 12.54 | 38 |
| 7.49 | 11.79 | 20 |
| 9.03 | 9.79 | 25 |
| 10.29 | 8.59 | 58 |
| 15.10 | 5.86 | 6 |
| 19.38 | 4.58 | 3 |
| 20.80 | 4.27 | 14 |
| 22.86 | 3.89 | 100 |
| 23.33 | 3.81 | 66 |
| 25.47 | 3.49 | 5 |
| 28.50 | 3.13 | 6 |
| 31.30 | 2.86 | 13 |
| 37.39 | 2.40 | 5 |

### Example 9: 1,1′-(butane-1,4-diyl)bis(2,4,6-trimethylpyridin-1-ium) dihydroxide (Structure 19)

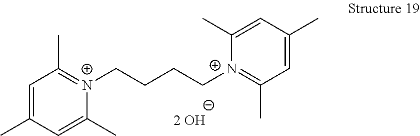

The bis-pyridinium compound (Structure 19) was formed by mixing 2,4,6-collidine and 1,4-dibromobutane following the general procedure described above. A 10.8 wt % aqueous solution was utilized for the zeolite syntheses below.

### High-Throughput STW Zeolite Synthesis Screening Reactions Using Structure 19

The aqueous SDA solution (Structure 19) was utilized for a series of high-throughput zeolite synthesis screening reactions. Pre-synthesis ratios of the reactants, reaction temperatures, and reaction times for various samples are specified in Table 26 below. The characterization results in Table 26 are based upon analysis of the powder XRD pattern of the products (not shown) in comparison to a known sample of STW.

TABLE 26

| Sample | SDA:Si | H₂O:Si | Si:T^{+3,4} | Silica |
|---|---|---|---|---|
| No. | (atomic) | (atomic) | (atomic) | Source |
| 82 | 0.25 | 10 | All-silica | TMOS |
| 83 | 0.25 | 10 | T = Ge, 7.3 | TMOS |
| 84 | 0.25 | 10 | T = Ge, 4 | TMOS |
| Sample | F:Si | Temperature | Reaction Time | |
| No. | (atomic) | (° C.) | (days) | Result |
| 82 | 0.5 | 150 | 28 | STW with trace |
| | | | | layered |
| 83 | 0.5 | 175 | 7 | STW with traces of |
| | | | | unidentified material |
| 84 | 0.5 | 175 | 7 | STW with traces of |
| | | | | unidentified material |

### Example 10: 1,1′-(butane-1,4-diyl)bis(2,3,5-trimethylpyridin-1-ium) dihydroxide (Structure 20)

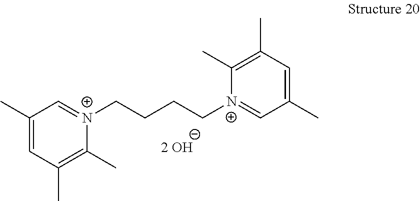

The bis-pyridinium compound (Structure 20) was formed by mixing 2,3,5-collidine and 1,4-dibromobutane following the general procedure described above. A 17.6 wt % aqueous solution was utilized for the zeolite syntheses below.

### High-Throughput STW Zeolite Synthesis Screening Reactions Using Structure 20

The aqueous SDA solution (Structure 20) was utilized for a series of high-throughput zeolite synthesis screening reactions. Pre-synthesis ratios of the reactants, reaction temperatures, and reaction times for various samples are specified in Table 27 below. The characterization results in Table 27 are based upon analysis of the powder XRD pattern of the products (not shown) in comparison to a known sample of STW.

TABLE 27

| Sample | SDA:Si | H₂O:Si | Si:T^{+3,4} | Silica |
|---|---|---|---|---|
| No. | (atomic) | (atomic) | (atomic) | Source |
| 85 | 0.25 | 4 | T = Ge, 7.3 | TMOS |
| 86 | 0.25 | 4 | T = Ge, 7.3 | TMOS |
| 87 | 0.25 | 4 | T = Ge, 4 | TMOS |
| 88 | 0.25 | 4 | T = Ge, 4 | TMOS |
| Sample | F:Si | Temperature | Reaction Time | |
| No. | (atomic) | (° C.) | (days) | Result |
| 85 | 0.5 | 175 | 7 | STW, layered |
| 86 | 0.5 | 175 | 7 | STW, layered |
| 87 | 0.5 | 175 | 7 | STW, layered |
| 88 | 0.5 | 175 | 7 | STW, layered |

### High-Throughput PST-22 Zeolite Synthesis Screening Reactions Using Structure 20

The aqueous SDA solution (Structure 20) was utilized for a series of high-throughput zeolite synthesis screening reactions. Pre-synthesis ratios of the reactants, reaction temperatures, and reaction times for various samples are specified in Table 28 below. The characterization results in Table 28 are based upon analysis of the powder XRD pattern of the products in comparison to a known sample of PST-22.

TABLE 28

| Sample | SDA:Si | H₂O:Si | Si:T^{+3,4} | Silica |
|---|---|---|---|---|
| No. | (atomic) | (atomic) | (atomic) | Source |
| 89 | 0.25 | 4 | All-silica | TMOS |
| 90^{a} | 0.25 | 5 | All-silica | TMOS |
| 91 | 0.25 | 5 | All-silica | TMOS |
| 92 | 0.25 | 5 | B, 40 | TMOS |
| Sample | F:Si | Temperature | Reaction Time | |
| No. | (atomic) | (° C.) | (days) | Result |
| 89 | 0.5 | 175 | 7 | PST-22 precursor |
| 90 | 0.5 | 175 | 7 | PST-22 precursor, |
| | | | | minor NON |
| 91 | 0.5 | 175 | 7 | PST-22 precursor |
| 92 | 0.5 | 175 | 7 | PST-22 precursor |

^{a}used 5 mg ITQ-21 zeolite seed per 100 g silica source

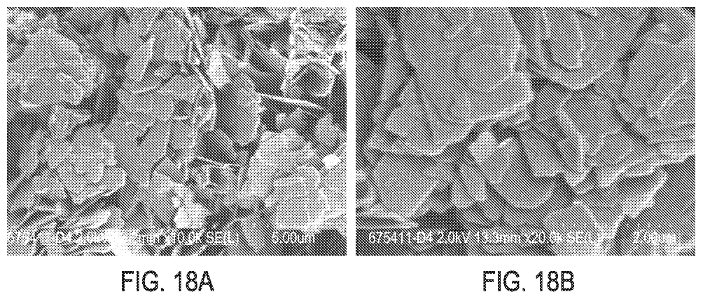

FIG. 17 shows comparative powder XRD patterns of Sample 89 pre-calcination (as-made) and post-calcination. The change in the powder pattern was consistent with that of a layered phase that condensed to form an intact PST-22 zeolite after the calcination.

The X-ray diffraction pattern of the all-silica PST-22 zeolite precursor (Sample 85) included the peaks in Table 29.

TABLE 29

| 2θ scattering angles | d-spacing | Relative Intensity |
|---|---|---|
| (+/− 0.20 degrees) | (Å) | [100 × I/I(o)] (%) |
| 6.79 | 13.00 | 14 |
| 8.41 | 10.50 | 100 |
| 11.20 | 7.89 | 7 |
| 12.67 | 6.98 | 5 |
| 15.27 | 5.80 | 16 |
| 16.57 | 5.35 | 6 |
| 16.88 | 5.25 | 8 |
| 19.29 | 4.60 | 6 |
| 19.88 | 4.46 | 13 |
| 20.46 | 4.34 | 16 |
| 21.19 | 4.19 | 16 |
| 22.26 | 3.99 | 10 |
| 24.83 | 3.58 | 17 |
| 25.84 | 3.45 | 29 |
| 26.15 | 3.40 | 17 |
| 27.21 | 3.28 | 8 |
| 28.34 | 3.15 | 6 |
| 30.16 | 2.96 | 7 |
| 34.27 | 2.61 | 5 |

The X-ray diffraction pattern of the all-silica PST-22 zeolite (Sample 85) after calcination at 600° C. included the peaks in Table 30.

TABLE 30

| 2θ scattering angles | d-spacing | Relative Intensity |
|---|---|---|
| (+/− 0.20 degrees) | (Å) | [100 × I/I(o)] (%) |
| 9.01 | 9.81 | 4 |
| 9.83 | 8.99 | 100 |
| 11.06 | 7.99 | 17 |
| 15.16 | 5.84 | 15 |
| 16.60 | 5.34 | 3 |
| 18.22 | 4.87 | 11 |
| 22.50 | 3.95 | 17 |
| 23.16 | 3.84 | 5 |
| 24.81 | 3.59 | 4 |
| 26.43 | 3.37 | 12 |
| 28.31 | 3.15 | 4 |
| 31.74 | 2.82 | 3 |

FIGS. 18A and 18B show illustrative SEM images of Sample 89 at various magnifications, made using the bis-pyridinium compound having Structure 20. As shown in FIGS. 18A and 18B, Sample 89 was composed of thin plates.

### Example 11: 1,1′-(pentane-1,5-diyl)bis(2,3,5-trimethylpyridin-1-ium) dihydroxide (Structure 21)

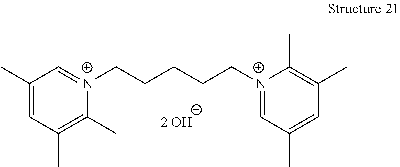

The bis-pyridinium compound (Structure 21) was formed by mixing 2,3,5-collidine and 1,5-dibromopentane following the general procedure described above. A 15.7 wt % aqueous solution was utilized for the zeolite syntheses below.

### High-Throughput PST-22 Zeolite Synthesis Screening Reactions Using Structure 21

The aqueous SDA solution (Structure 21) was utilized for a series of high-throughput zeolite synthesis screening reactions. Particular pre-synthesis ratios of the reactants, reaction temperatures, and reaction times for various samples are specified in Table 31 below. The characterization results in Table 31 are based upon analysis of the powder XRD pattern of the products (not shown) in comparison to a known sample of PST-22.

TABLE 31

| Sample | SDA:Si | H₂O:T⁺⁴ | Si:T^{+3,4} | MOH:Si | Silica |
|---|---|---|---|---|---|
| No. | (atomic) | (atomic) | (atomic) | (atomic) | Source |
| 93 | 0.15 | 44 | T = Al, 40 | M = Na, 0.70 | A |
| 94 | 0.15 | 42 | T = Al, 40 | M = Na, 0.70 | A |
| 95 | 0.15 | 30 | T = Al, 10 | M = Na, 0.15 | L |
| 96 | 0.15 | 35 | T = Al, 20 | M = Na, 0.30 | A |
| | | | | Reaction | |
| Sample | T⁺³ | HCl:Si | Temperature | Time | |
| No. | Source | (atomic) | (° C.) | (days) | Result |
| 93 | S | 0.25 | 160 | 28 | 60% PST-22, |
| | | | | | 40% quartz |
| 94 | S | 0 | 160 | 28 | PST-22 with |
| | | | | | minor quartz |
| 95 | S | 0.15 | 160 | 7 | PST-22 |
| 96 | S | 0 | 160 | 7 | PST-22 |

### Example 12: 1,1′-(hexane-1,6-diyl)bis(2,3,5-trimethylpyridin-1-ium) dihydroxide (Structure 22)

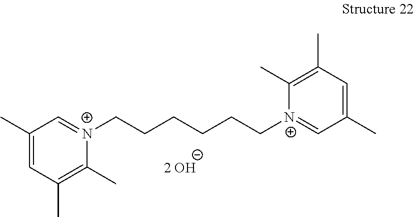

The bis-pyridinium compound (Structure 22) was formed by mixing 2,3,5-collidine and 1,6-dibromohexane following the general procedure described above. A 10.4 wt % aqueous solution was utilized for the zeolite syntheses below.

### High-Throughput ATS Zeolite Synthesis Screening Reactions Using Structure 22

The aqueous SDA solution (Structure 22) was utilized for a series of high-throughput zeolite synthesis screening reactions. The alumina source (CATAPAL® A SASOL, 69.3 wt % Al₂O₃) was added to phosphoric acid (50 wt %) and deionized water. To this mixture was added magnesium acetate tetrahydrate (25 wt % in water). The aqueous SDA solution (Structure 22) was then added, and mixed to create a uniform suspension. Each reaction (Samples 97-99) was performed at 200° C. for 2 days. Particular pre-synthesis ratios of the reactants, reaction temperatures, and reaction times for various samples are specified in Table 32 below. The characterization results in Table 32 are based upon analysis of the powder XRD pattern of the products (not shown) in comparison to a known sample of ATS.

TABLE 32

| Sample | SDA:T^{a} | H₂O:T | Al:T | P:Al | | | Mg: T |
|---|---|---|---|---|---|---|---|
| No. | (atomic) | (atomic) | (atomic) | (atomic) | Si:Al | HF:Si | (atomic) |
| 97^{b} | 0.116 | 26 | 0.474 | 1.11 | 0 | 0 | 0.05 |
| 98^{b} | 0.139 | 29 | 0.444 | 1.25 | 0 | 0 | 0.10 |
| 99^{b, c} | 0.232 | 41 | 0.465 | 1.00 | 0.15 | 0 | 0 |

| Sample | Temperature | Reaction Time | |
|---|---|---|---|
| No. | (° C.) | (days) | Result |
| 97 | 200 | 2 | ATS |
| 98 | 200 | 2 | ATS |
| 99 | 200 | 2 | ATS |

^{a}T = sum of T atoms (Al + P + Mg)
^{b}AERODISP ® W 7330 N (69.3 wt. %)
^{c}LUDOX ® LS-30

### Example 13: 1,1′-(butane-1,4-diyl)bis(6,7-dihydro-5H-cyclopenta[b]pyridin-1-ium) dihydroxide (Structure 23)

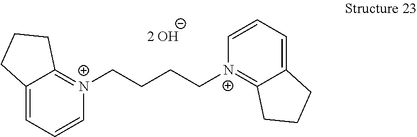 [SMILES: c1cc2c([n+](CCCC[n+]3cccc4c3CCC4)c1)CCC2]

The bis-pyridinium compound (Structure 23) was formed by mixing 2,3-cyclopentenopyridine and 1,4-dibromobutane following the general procedure described above. A 7.9 wt % aqueous solution was utilized for the zeolite syntheses below.

### Zeolite Synthesis Screening Reactions Using Structure 23

The aqueous solution of the SDA (Structure 23) was utilized for a zeolite synthesis screening reaction. Particular pre-synthesis ratios of the reactants, reaction temperatures, and reaction times are specified in Table 33 below. The characterization results in Table 33 are based upon analysis of the powder XRD pattern of the products (not shown) in comparison to a known sample of STW.

TABLE 33

| Sample | SDA:Si | H₂O:Si | Si:^{+3,4+} | Silica |
|---|---|---|---|---|
| No. | (atomic) | (atomic) | (atomic) | Source |
| 100 | 0.25 | 10 | T = Ge, 4 | TMOS |
| Sample | F:Si | Temperature | Reaction Time | |
| No. | (atomic) | (° C.) | (days) | Result |
| 100 | 0.5 | 175 | 7 | STW, minor layered |

### Example 14: 1,1′-(pentane-1,5-diyl)bis(6,7-dihydro-5H-cyclopenta[b]pyridin-1-ium) dihydroxide (Structure 24)

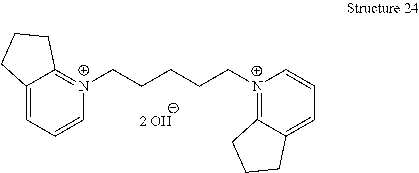 [SMILES: c1cc2c([n+](CCCCC[n+]3cccc4c3CCC4)c1)CCC2]

The bis-pyridinium compound (Structure 24) was formed by mixing 2,3-cyclopentenopyridine and 1,5-dibromopentane following the general procedure described above. A 8.37 wt % aqueous solution was utilized for the zeolite syntheses below.

### Zeolite Synthesis Screening Reactions Using Structure 24

The aqueous SDA solution (Structure 24) was utilized for a zeolite synthesis screening reaction. Particular pre-synthesis ratios of the reactants, reaction temperatures, and reaction times for various samples are specified in Table 34 below. The characterization results in Table 34 are based upon analysis of the powder XRD pattern of the products (not shown) in comparison to a known sample of STW.

TABLE 34

| Sample | SDA:Si | H₂O:Si | Si:T^{+3,4} | | |
|---|---|---|---|---|---|
| No. | (atomic) | (atomic) | (atomic) | T Source | |
| 101 | 0.25 | 10 | 4 | Ge | |
| Sample | Silica | F:Si | Temperature | Reaction | |
| No. | Source | (atomic) | (° C.) | Time (days) | Result |
| 101 | TMOS | 0.5 | 175 | 7 | STW with trace |
| | | | | | unidentified |

### Example 15: 1,1′-(butane-1,4-diyl)bis(5,6,7,8-tetrahydroquinolin-1-ium) dihydroxide (Structure 25)

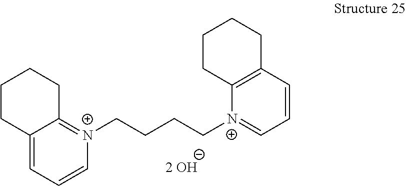 [SMILES: c1cc2c([n+](CCCC[n+]3cccc4c3CCCC4)c1)CCCC2]

The bis-pyridinium compound (Structure 25) was formed by mixing 5,6,7,8-tetrahydroquinoline and 1,4-dibromobutane following the general procedure described above. An 8.4 wt % aqueous solution was utilized for the zeolite syntheses below.

### High-Throughput Zeolite Synthesis Screening Reactions

The aqueous SDA solution (Structure 25) was utilized for a series of high-throughput zeolite synthesis screening reactions. Particular pre-synthesis ratios of the reactants, reaction temperatures, and reaction times for various samples are specified in Table 35 below. The characterization results in Table 35 are based upon analysis of the powder XRD pattern of the products (not shown) in comparison to a known sample of STW.

TABLE 35

| Sample | SDA:Si | H₂O:Si | Si:T^{+3,4} | |
|---|---|---|---|---|
| No. | (atomic) | (atomic) | (atomic) | Silica Source |
| 102 | 0.25 | 4 | T = Ge, 7.3 | TMOS |
| 103^{a} | 0.25 | 4 | All-silica | TMOS |
| 104ª | 0.25 | 4 | All-silica | TMOS |
| Sample | F:Si | Temperature | Reaction | |
| No. | (atomic) | (° C.) | Time (days) | Result |
| 102 | 0.5 | 150 | 28 | STW, minor layered |
| 103 | 0.5 | 150 | 28 | STW, minor layered |
| 104 | 0.5 | 150 | 10 | STW with trace layered |

^{a}used 5 mg ITQ-33 zeolite seeds per 100 mg silica source

### Example 16: 1,1′-(pentane-1,5-diyl)bis(4-phenylpyridin-1-ium) dihydroxide (Structure 26)

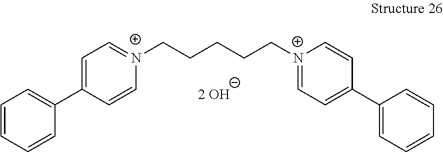 [SMILES: c1ccc(-c2cc[n+](CCCCC[n+]3ccc(-c4ccccc4)cc3)cc2)cc1]

The bis-pyridinium compound (Structure 26) was formed by mixing 4-phenylpyridine and 1,5-dibromopentane following the general procedure described above. A 6.75 wt % aqueous solution was utilized for the zeolite syntheses below.

### High-Throughput ZSM-12 Zeolite Synthesis Screening Reactions Using Structure 26

The aqueous SDA solution (Structure 26) was utilized for a series of high-throughput zeolite synthesis screening reactions. Pre-synthesis ratios of the reactants, reaction temperatures, and reaction times for various samples are specified in Table 36 below. The characterization results in Table 36 are based upon analysis of the powder XRD pattern of the products (not shown) in comparison to a known sample of ZSM-12.

TABLE 36

| Sample | SDA:Si | H₂O:T⁺⁴ | Si:T^{+3,4} | MOH:Si | Silica |
|---|---|---|---|---|---|
| No. | (atomic) | (atomic) | (atomic) | (atomic) | Source |
| 105 | 0.10 | 68 | T = B, 5 | M = Li, 0.30 | L |
| 106 | 0.10 | 44 | T = B, 40 | M = Na, 0.10 | L |

| | | Temper- | Reaction | |
|---|---|---|---|---|
| Sample | HCl:Si | ature | Time | |
| No. | (atomic) | (° C.) | (days) | Result |
| 106 | 0 | 160 | 14 | ZSM-12 |
| 107 | 0 | 160 | 14 | ZSM-12 |

All documents described herein are incorporated by reference herein for purposes of all jurisdictions where such practice is allowed, including any priority documents and/or testing procedures to the extent that they are not inconsistent with this text. As is apparent from the foregoing general description and the specific embodiments, while forms of the disclosure have been illustrated and described, various modifications may be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

The invention claimed is:

1-21. (canceled)

22. A composition comprising:
an at least partially crystalline network structure comprising a silicate having a plurality of pores or channels defined therein; and
a bis-pyridinium compound present in at least a portion of the pores or channels, the bis-pyridinium compound having a structure represented by: 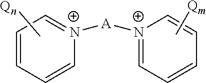
wherein Q is an optionally substituted C₁-C₁₀ hydrocarbyl group and two Q may join to form a carbocyclic ring, n is an integer ranging from 0 to 5, m is an integer ranging from 0 to 5, n+m is greater than or equal to 1, and A is a spacer group containing 2 to about 10 atoms.

23. The composition of claim 22, wherein A is (CH₂)₄, (CH₂)₅ or (CH₂)₆.

24. The composition of claim 22, wherein the bis-pyridinium compound has a structure selected from the group consisting of

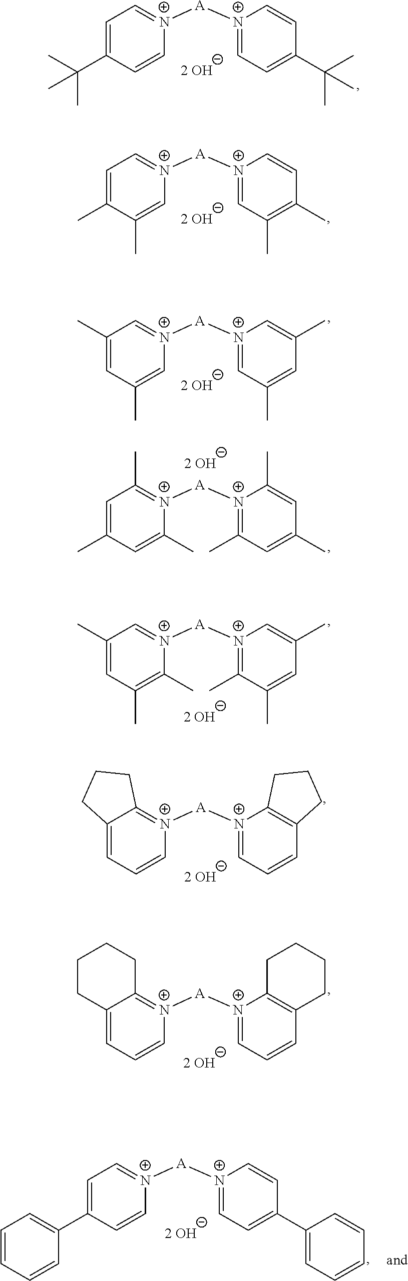

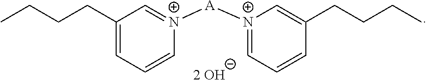

25. The composition of claim 22, wherein the bis-pyridinium compound has a structure selected from the group consisting of

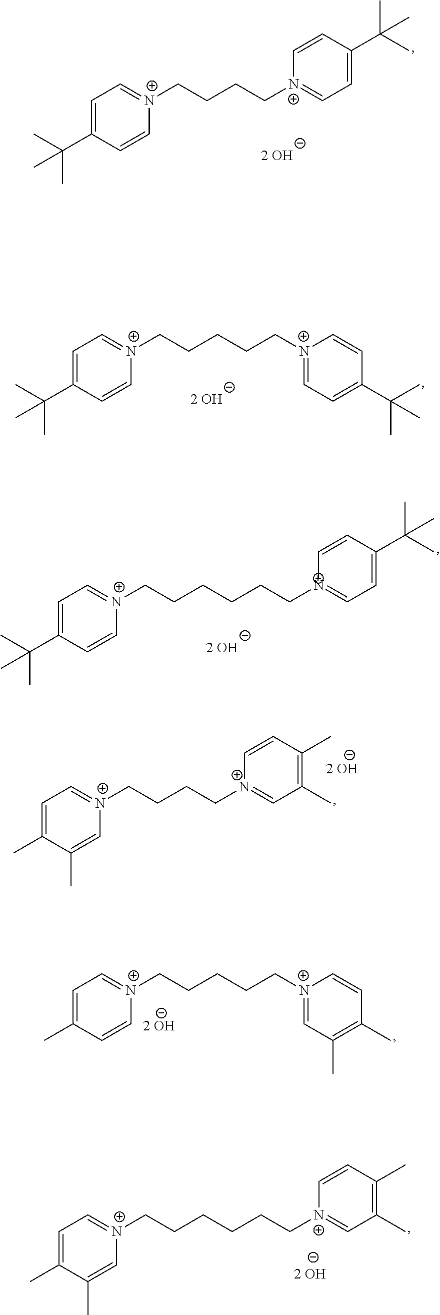

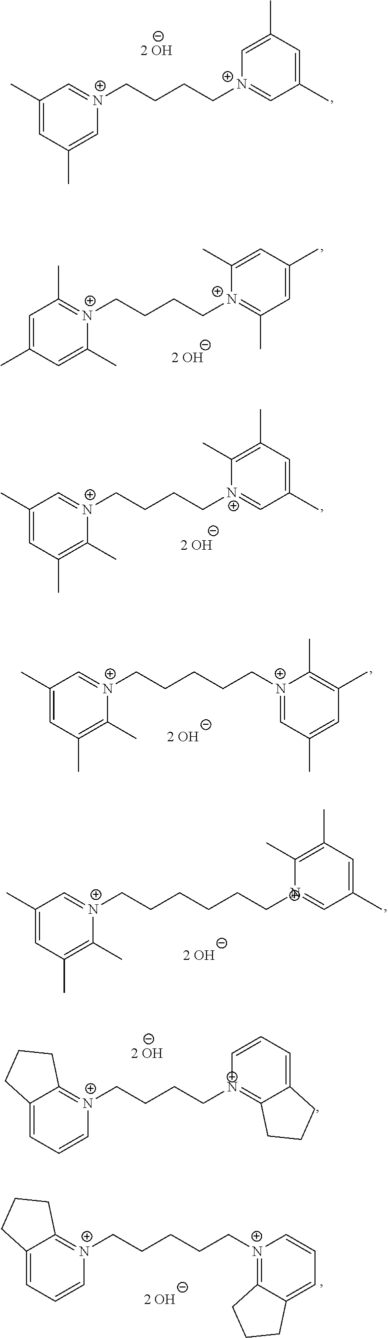

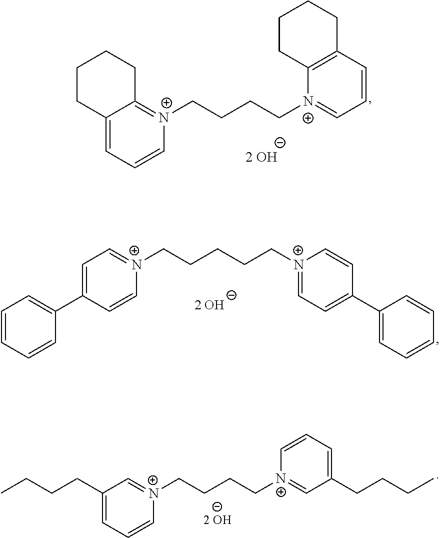 [SMILES: c1cc2c([n+](CCCC[n+]3cccc4c3CCCC4)c1)CCCC2 ; c1ccc(-c2cc[n+](CCCCC[n+]3ccc(-c4ccccc4)cc3)cc2)cc1 ; CCCCc1ccc[n+](CCCC[n+]2cccc(CCCC)c2)c1]

26. The composition of claim 22, wherein the at least partially crystalline network structure comprises a trivalent element selected from the group consisting of B, Al, Fe, Ga, and any combination thereof.

27. The composition of claim 22, wherein the at least partially crystalline network structure comprises a tetravalent element selected from the group consisting of Ge, Sn, Ti, and any combination thereof.

28. The composition of claim 22, wherein the at least partially crystalline network structure comprises a pentavalent element, the pentavalent element being phosphorus.

29. The composition of claim 22, wherein the at least partially crystalline network structure has a Si:Al atomic ratio of about 10 or greater.

30. The composition of claim 22, wherein the at least partially crystalline network structure has a Si:B atomic ratio of about 10 or greater.

31. A process comprising:
combining in an aqueous medium a silicon atom source and a bis-pyridinium compound having a structure represented by: 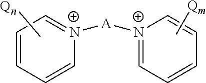
wherein Q is an optionally substituted C₁-C₁₀ hydrocarbyl group and two Q may join to form a carbocyclic ring, n is an integer ranging from 0 to 5, m is an integer ranging from 0 to 5, n+m is greater than or equal to 1, and A is a spacer group containing 2 to about 10 atoms;
heating the aqueous medium under crystallization conditions; and
obtaining an at least partially crystalline network structure from the aqueous medium.

32. The process of claim 31, wherein A is (CH₂)₄, (CH₂)₅ or (CH₂)₆.

33. The process of claim 31, wherein the bis-pyridinium compound has a structure selected from the group consisting of

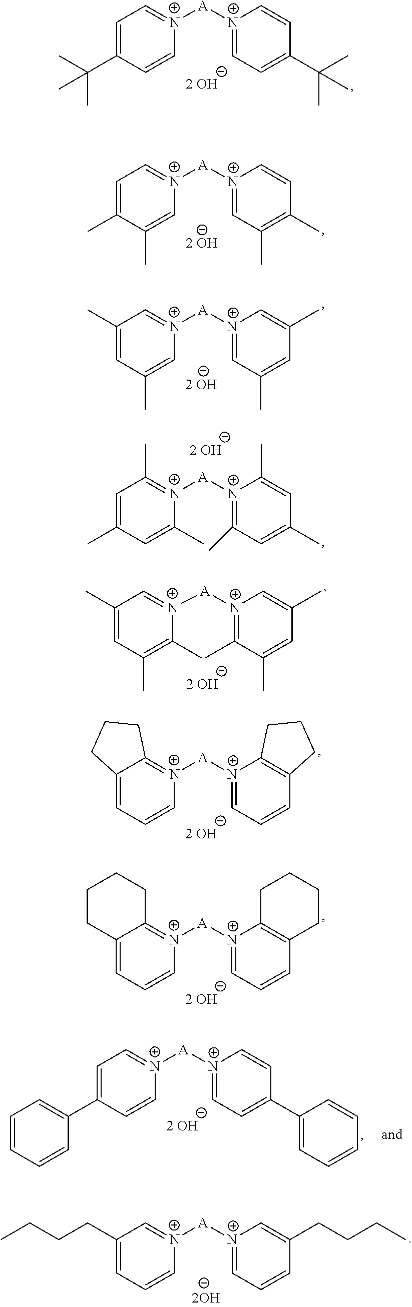

34. The process of claim 31, wherein the bis-pyridinium compound has a structure selected from the group consisting of

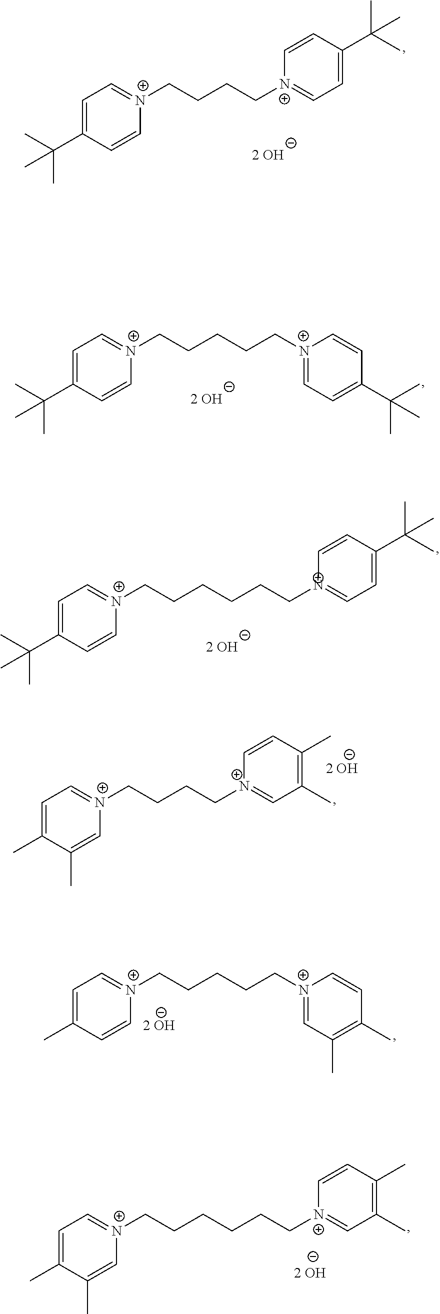

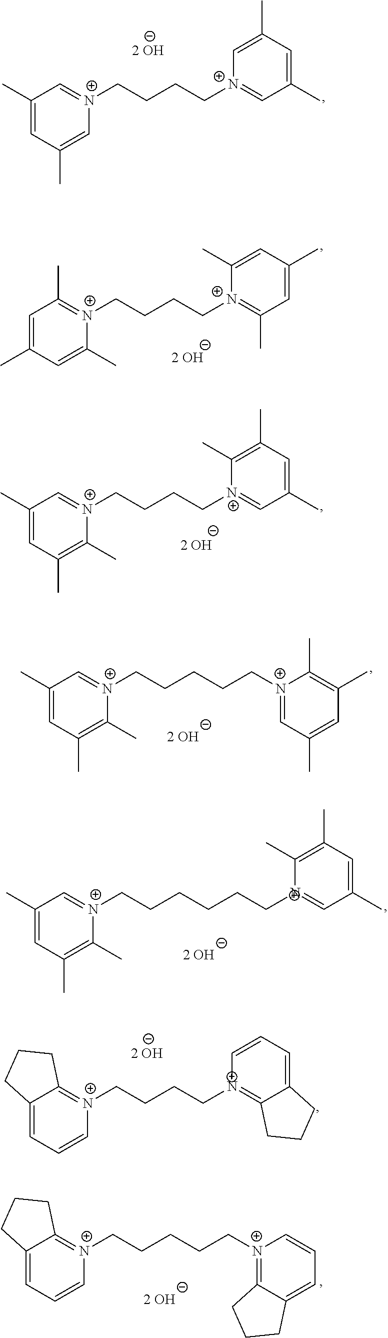

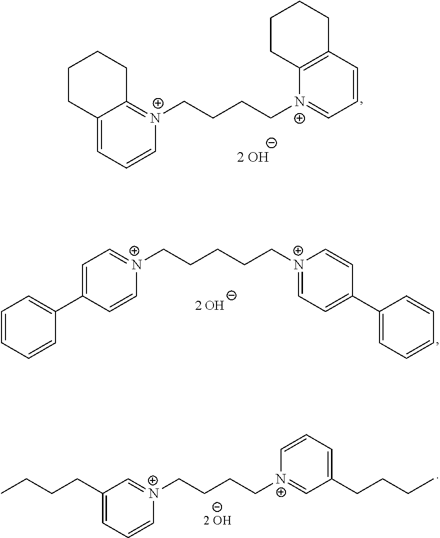 [SMILES: c1cc2c([n+](CCCC[n+]3cccc4c3CCCC4)c1)CCCC2 ; c1ccc(-c2cc[n+](CCCCC[n+]3ccc(-c4ccccc4)cc3)cc2)cc1 ; CCCCc1ccc[n+](CCCC[n+]2cccc(CCCC)c2)c1]

35. The process of claim 31, wherein the at least partially crystalline network structure has a Si:Al atomic ratio of about 10 or greater.

36. The process of claim 31, wherein the at least partially crystalline network structure has a Si:B atomic ratio of about 10 or greater.

37. The process of claim 31, wherein a trivalent element source is present in the aqueous medium, the trivalent metal being selected from the group consisting of B, Al, Fe, Ga, and any combination thereof.

38. The process of claim 31, wherein a tetravalent element source is present in the aqueous medium, the tetravalent element being selected from the group consisting of Si, Ge, Sn, Ti, and any combination thereof.

39. The process of claim 31, wherein a pentavalent element source is present in the aqueous medium, the pentavalent element being phosphorus.

40. The process of claim 31, further comprising:
calcining the at least partially crystalline network structure in air or oxygen to remove the bis-pyridinium compound from the at least partially crystalline network structure.

41. The process of claim 31, wherein the at least partially crystalline network structure has a framework type selected from the group consisting of PST-22, EMM-17, EMM-69, and EMM-XY.
